(19) United States
(12) Patent Application Publication
(10) Pub. No.: US 2010/0068686 A1
(43) Pub. Date: Mar. 18, 2010

(54) MEMORY TESTING APPARATUS, JUDGMENT TESTING APPARATUS, COMPARISON-FACULTY TESTING APPARATUS, COORDINATION TRAINING APPARATUS, AND WORKING MEMORY TRAINING APPARATUS

(76) Inventor: Hiromu UESHIMA, Shiga (JP)

Correspondence Address: JEROME D. JACKSON (JACKSON PATENT LAW OFFICE), 211 N. UNION STREET, SUITE 100, ALEXANDRIA, VA, 22314, US

(21) Appl. No.: 12/096,792

(22) PCT Filed: Dec. 11, 2006
(86) PCT No.: PCT/JP2006/325132

§ 371 Date: Apr. 17, 2009

(30) Foreign Application Priority Data
Dec. 12, 2005 (JP) 2005-357531

(51) Int. Cl. G09B 19/00

(52) U.S. Cl. 434/258

(57) ABSTRACT

By indicating order of inputting by two rackets RK1 and RK2 in a task displaying area 178 displayed on a television monitor 100 and having a user memorize the order, and further by having the user perform input operation at indicated timing, it is possible to test extent of short term memory of the user based on whether or not the input operation is performed using the indicated racket in the indicated order. Since the input operation is performed by swinging the rackets RK1 and RK2, it is possible to test the short term memory of the user while moving a body.

### TECHNICAL FIELD

The present invention relates to a memory testing apparatus for testing short term memory of a user, a judgment testing apparatus for testing judgment of a user, a comparison-faculty testing apparatus for testing a faculty of comparison of a user, and the related arts.

### BACKGROUND ART

The Patent Document (Japanese Unexamined Patent Application Publication No. 2001-104636) by the present applicant discloses a bodily sensible baseball game apparatus which has a game machine connected with a television monitor, and a bat type input device with an acceleration sensor. An acceleration signal is transmitted to an infrared receiver of the game machine by an infrared ray LED, whereby the game machine computes a moving velocity of the bat type input device, and then computes moving parameters of a ball to be hit back on the basis of the moving velocity. Accordingly, the ball hit back moves in accordance with the parameters on a game screen. Since a game player swings the bat type input device actually, he/she can enjoy the baseball game with feeling close to that of the real baseball. Therefore, it is often called a simulation game. Various kinds of bodily sensible games are sold, and whereby it is possible to experience various sports simulatively.

Since sports are played by moving a body, an idea of playing a sport video game while actually moving the body was innovative at the time when the Patent Document was filed.

However, there are many matters in the world each of which is essentially not played by moving the body, i.e., is played by using only fingertips. When such matter is played, if it can be played while moving the body, not only can it achieve an original purpose, but it can also be expected distinguished effect for health.

It is therefore an object of the present invention to provide a memory testing apparatus and the related arts capable of testing short term memory of a user while moving a body.

It is another object of the present invention to provide a judgment testing apparatus and the related arts capable of testing judgment of a user while moving a body.

It is a further object of the present invention to provide a comparison-faculty testing apparatus and the related arts capable of testing a faculty of comparison of a user while moving a body.

### DISCLOSURE OF INVENTION

In accordance with the first aspect of the present invention, the memory testing apparatus comprising: a plurality of input devices; an input detecting unit operable to detect whether or not there is an input for said each input device; an input order indicating unit operable to indicate order of the inputs by said plurality of the input devices to a user by means of a display device; and an input timing indicating unit operable to indicate timing of the inputs by said input devices to the user by means of the display device.

In accordance with this configuration, by indicating order of inputting by the plurality of the input devices to the user and having the user memorize the order, and further by having the user perform the input operation at indicated timing, it is possible to easily test extent of short term memory of the user based on whether or not the input operation is performed using the indicated input device in the indicated order.

In the above memory testing apparatus, said plurality of the input devices are provided as a single body respectively.

In accordance with this configuration, it is possible to have the user perform the input operation by moving different parts of a body. For example, the input devices are held with left and right hands respectively, and so on. In contrast, in the case where a plurality of input devices (a plurality of buttons) is implemented in a single apparatus such as a remote, it is possible to be operated by a single finger.

In the above memory testing apparatus, each of said input devices includes a movement detecting unit which detects movement of said input device and generate a signal in accordance with the movement, and wherein said input detecting unit determines whether or not there is the input based on the signal from said movement detecting unit.

In accordance with this configuration, the user performs the input operation by moving the body, and therefore it is possible to contribute to maintain or improve the health of the user.

In the above memory testing apparatus, said movement detecting unit includes an acceleration sensor, and generates the signal in accordance with acceleration detected by said acceleration sensor.

In the above memory testing apparatus, said input detecting unit includes an imaging unit which photographs said input device, and detects whether or not there is the input based on a picture obtained by said imaging unit.

In accordance with this configuration, it photographs the movement of the user, and detects whether or not there is the input based on the result of the photographing. Thus, the user performs the input operation by moving the body, and therefore it is possible to contribute to maintain or improve the health of the user.

In the above memory testing apparatus, each of said input devices includes any one of a light-emitting unit which spontaneously emits light and a reflection unit which retroreflectively reflects light.

In accordance with this configuration, it is possible to detect the input device with a higher degree of accuracy using a simple process.

The above memory testing apparatus further comprises a hiding unit operable to control display of the display device in order that the order of the input is not recognized by the user after indicating the order of the input to the user by means of the display device.

In accordance with this configuration, since the time when the user memorizes the order of the inputs is restricted, it is possible to increase degree of difficulty of the memory test.

In the above memory testing apparatus, said input order indicating unit displays the order of the inputs at a time on the display device.

In accordance with this configuration, it is possible to perform a memory test with relatively low degree of difficulty.

In the above memory testing apparatus, said input order indicating unit successively displays the order of the inputs from either the earlier input or the later input on the display device.

In accordance with this configuration, since the order of the inputs is indicated not at a time but in sequence, the time for memorizing becomes short. As a result, it is more difficult for the user to memorize, and therefore it is possible to perform the memory test with high degree of difficulty.

In the above memory testing apparatus, said input order indicating unit successively displays the order of the inputs from either the earlier input or the later input on the display device, and controls display of the display device in order that the order of the input is not recognized by the user after displaying the order of the input on the display device and before displaying the order of the last input.

In accordance with this configuration, since the term when the order of the inputs is shown becomes short, it is possible to perform the memory test with higher degree of difficulty.

The above memory testing apparatus further comprises a determining unit operable to determine whether or not the inputs by said input device are performed in the indicated order and at the indicated timing.

In accordance with this configuration, the user can know the objective determination about his/her short term memory by the determination result of the determining unit.

In accordance with the second aspect of the present invention, the judgment testing apparatus comprising: an input device; an input detecting unit operable to detect whether or not there is an input by said input device; an input content indicating unit operable to indicate to perform the input using said input device to a user by means of any one or an arbitrary combination of a letter to be displayed on a display device, a drawing to be displayed on the display device, a color to be displayed on the display device, and voice to be output by a sound outputting device; an input timing indicating unit operable to indicate timing of the input by said input device to the user by displaying an image representing a content which corresponds to a content indicated by said input content indicating unit on the display device and/or by outputting voice representing a content which corresponds to a content indicated by said input content indicating unit from said sound outputting unit; and a feigned input timing indicating unit operable to indicate feigned timing of the input by said input device to the user by displaying an image representing a content which does not correspond to the content indicated by said input content indicating unit on the display device and/or by outputting voice representing a content which does not correspond to a content indicated by said input content indicating unit from said sound outputting unit.

In accordance with this configuration, since the judgment of the user is deluded by indicating the feigned input timing to the user, it is possible to easily test the extent of the judgment of the user base on whether or not the input operation by the input device is performed at the correct timing.

In the judgment testing apparatus, said input device includes a movement detecting unit which detects movement of said input device and generate a signal in accordance with the movement, and wherein said input detecting unit determines whether or not there is the input based on the signal from said movement detecting unit.

In accordance with this configuration, the user performs the input operation by moving the body, and therefore it is possible to contribute to maintain or improve the health of the user.

In the judgment testing apparatus, said movement detecting unit includes an acceleration sensor, and generates the signal in accordance with acceleration detected by said acceleration sensor.

In the judgment testing apparatus, said input detecting unit includes an imaging unit which photographs said input device, and detects whether or not there is the input based on a picture obtained by said imaging unit.

In accordance with this configuration, it photographs the movement of the user, and detects whether or not there is the input based on the result of the photographing. Thus, the user performs the input operation by moving the body, and therefore it is possible to contribute to maintain or improve the health of the user.

In the judgment testing apparatus, said input device includes any one of a light-emitting unit which spontaneously emits light and a reflecting unit which retroreflectively reflects light.

In accordance with this configuration, it is possible to detect the input device with a higher degree of accuracy using a simple process.

In the judgment testing apparatus, when an indication of the input is performed by means of an arbitrary combination of elements such as the letter, the drawing, the color, and the voice, said input content indicating unit gives a feigned indication by means of the at least one element.

In accordance with this configuration, since the elements which delude the judgment of the user are increased, it is possible to increase the degree of difficulty. Also, it is possible to easily control the degree of difficulty by the number of the elements each of which shows the feigned indication.

In the judgment testing apparatus further comprises a determining unit operable to determine whether or not the input by said input device is performed in accordance with the indicated content at the indicated timing.

In accordance with this configuration, the user can know the objective determination about his/her judgment by the determination result of the determining unit.

In accordance with the third aspect of the present invention, the comparison-faculty testing apparatus comprising: a plurality of input devices; and an input detecting unit operable to detect whether or not there is an input for said each input device, wherein a screen to be displayed on a display device is divided into a plurality of divisions, and said comparison-faculty testing apparatus further comprising: a display controlling unit operable to display objects assigned for each of the divisions on each of the divisions.

In accordance with this configuration, by having the user compare the displayed objects between the divisions, it is possible to easily test the extent of the comparison-faculty of the user based on whether or not the result of the comparison is correct.

In the above comparison-faculty testing apparatus, said plurality of the input devices are provided as a single body respectively.

In accordance with this configuration, it is possible to have the user perform the input operation by moving different parts of a body. For example, the input devices are held with left and right hands respectively, and so on. In contrast, in the case where a plurality of input devices (a plurality of buttons) is implemented in a single apparatus such as a remote, it is possible to be operated by a single finger.

In the above comparison-faculty testing apparatus, each of said input devices includes a movement detecting unit which detects movement of said input device and generate a signal in accordance with the movement, and wherein said input detecting unit determines whether or not there is the input based on the signal from said movement detecting unit.

In accordance with this configuration, the user performs the input operation by moving the body, and therefore it is possible to contribute to maintain or improve the health of the user.

In the above comparison-faculty testing apparatus, said movement detecting unit includes an acceleration sensor, and generates the signal in accordance with acceleration detected by said acceleration sensor.

In the above comparison-faculty testing apparatus, said input detecting unit includes an imaging unit which photographs said input device, and detects whether or not there is the input based on a picture obtained by said imaging unit.

In accordance with this configuration, it photographs the movement of the user, and detects whether or not there is the input based on the result of the photographing. Thus, the user performs the input operation by moving the body, and therefore it is possible to contribute to maintain or improve the health of the user.

In the above comparison-faculty testing apparatus, each of said input devices includes any one of a light-emitting unit which spontaneously emits light and a reflecting unit which retroreflectively reflects light.

In accordance with this configuration, it is possible to detect the input device with a higher degree of accuracy using a simple process.

In the above comparison-faculty testing apparatus, said display controlling unit changes degree of difficulty by means of any one or an arbitrary combination of number, movement, appearance, size, and moving velocity of the objects to be displayed on the each division. The appearance includes shape, design, or color, or an arbitrary combination thereof.

In accordance with the fourth aspect of the present invention, the coordination training apparatus comprising: at least one input device operable to detect an input operation of a user; a task outputting unit operable to output a predetermined task as an image to a display device, and/or, output the predetermined task as voice to a sound outputting device; and an evaluation outputting unit operable to perform evaluation based on a detection result of the input operation of the user by said input device, and the predetermined task, and output a evaluation result as an image to the display device, and/or, output the evaluation result as voice to the sound outputting device, wherein the predetermined task includes a task for training an arbitrary combination or any one of an orientation ability, a switch-over ability, a rhythm ability, a response ability, a balance ability, a coupling ability, and a differentiation ability of a human by cooperation with the input operation of the user by said input device, wherein said task outputting unit repeats to output the predetermined task while changing a content, wherein said evaluation outputting unit repeats to evaluate in accordance with change of the content of the predetermined task, and wherein said input device includes a detecting unit which detects movement of said input device and generate a detection signal in accordance with the movement, and detects the input operation of the user based on the detection signal.

In accordance with this configuration, contribution to improvement of the coordination ability of a human is anticipated. The coordination ability is defined as an ability to smoothly perform processes of a series of movements where a human detects situation using the five senses, determines it using a brain, and moves muscle specifically.

More specifically, the coordination ability includes a rhythm ability, a balance ability, a switch-over ability, a response ability, a coupling ability, an orientation ability, and a differentiation ability. The rhythm ability is an ability to represent rhythm of the movement based on visual information, acoustic information, and/or information imaged by a person with a body. The balance ability is an ability to maintain the proper balance and recover the deformed posture. The switch-over ability is an ability to quickly switch over movement in response to the change of condition. The response ability is an ability to quickly respond to a signal to deal appropriately. The coupling ability is an ability to smoothly move an entire body, i.e., an ability to adjust a force and a speed to laconically move a muscle and a joint of the partial body. The orientation ability is an ability to comprehend a positional relation between the moving object and one's own body. The differentiation ability is an ability to link hands and/or feet and/or instruments with a visual input to precisely operate them.

In the above coordination training apparatus, the plurality of said input devices is assigned to the one user, and wherein said evaluation outputting unit performs the evaluation based on the detection results of the input operations of the user by the plurality of said input devices, and the predetermined task.

In accordance with this configuration, since the user moves the plurality of the input devices using the plurality of the body parts, the more effective contribution to improvement of the coordination ability of a human is anticipated.

In accordance with the fifth aspect of the present invention, the working memory training apparatus comprising: at least one input device operable to detect an input operation of a user; a task outputting unit operable to output a predetermined task as an image to a display device, and/or, output the predetermined task as voice to a sound outputting device; and an evaluation outputting unit operable to perform evaluation based on a detection result of the input operation of the user by said input device, and the predetermined task, and output a evaluation result as an image to the display device, and/or, output the evaluation result as voice to the sound outputting device, wherein the predetermined task is a task which cooperates with the input operation of the user by the input device and increases activity of at least part of a prefrontal cortex of a brain when the user performs the predetermined task, wherein said task outputting unit repeats to output the predetermined task while changing a content, wherein said evaluation outputting unit repeats to evaluate in accordance with change of the content of the predetermined task, and wherein said input device includes a detecting unit operable to detect movement of said input device and generate a detection signal in accordance with the movement, and detects the input operation of the user based on the detection signal.

The user performs the predetermined task repeatedly with the aim of training the brain using this working memory training apparatus. Since the prefrontal area in the brain is intensively used during performance of the task and whereby activated intensively, the contribution to improvement of the activity of the working memory closely related to the activity of the prefrontal area is anticipated by repeating the predetermined task.

In accordance with the sixth aspect of the present invention, the working memory training apparatus comprising: at least one input device operable to detect an input operation of a user; a task outputting unit operable to output a predetermined task as an image to a display device, and/or, output the predetermined task as voice to a sound outputting device; and an evaluation outputting unit operable to perform evaluation based on a detection result of the input operation of the user by said input device, and the predetermined task, and output a evaluation result as an image to the display device, and/or, output the evaluation result as voice to the sound output device, wherein the predetermined task is a task which yields a measurement result where electric activity or metabolic activity of nerves of at least one part of a prefrontal area in a brain increases when the electric activity or the metabolic activity of the nerves in the brain is measured during the user performs the predetermined task while operating said input device, wherein said task outputting unit repeats to output the predetermined task while changing a content, wherein said evaluation outputting unit repeats to evaluate in accordance with change of the content of the predetermined task, and wherein said input device includes a detecting unit operable to detect movement of said input device and generate a detection signal in accordance with the movement, and detects the input operation of the user based on the detection signal.

The user performs the predetermined task repeatedly with the aim of training the brain using this working memory training apparatus. Since the electric activity or the metabolic activity of the prefrontal area in the brain increases during performance of the task, i.e., the prefrontal area in the brain is intensively used during performance of the task and whereby activated intensively, the contribution to improvement of the activity of the working memory closely related to the activity of the prefrontal area is anticipated by repeating the predetermined task.

In accordance with the seventh aspect of the present invention, the working memory training apparatus comprising: at least one input device operable to detect an input operation of a user; a task outputting unit operable to output a predetermined task as an image to a display device, and/or, output the predetermined task as voice to a sound output device; and an evaluation outputting unit operable to perform evaluation based on a detection result of the input operation of the user by said input device, and the predetermined task, and output a evaluation result as an image to the display device, and/or, output the evaluation result as voice to the sound output device, wherein the predetermined task is a task which has the user perform a predetermined process under a state where the user memorizes predetermined information temporarily. wherein said task outputting unit repeats to output the predetermined task while changing a content, wherein said evaluation outputting unit repeats to evaluate in accordance with change of the content of the predetermined task, and wherein said input device includes a detecting unit operable to detect movement of said input device and generate a detection signal in accordance with the movement, and detects the input operation of the user based on the detection signal.

In accordance with this configuration, it is possible to effectively train the working memory of the brain. Because, the predetermined task is a task which has the user perform the predetermined process under a state where the user memorizes the predetermined information temporarily.

In the above working memory training apparatuses in accordance with the fifth to seventh aspects, the plurality of said input devices is assigned to the one user, and wherein said evaluation outputting unit performs the evaluation based on the detection results of the input operations of the user by the plurality of said input devices, and the predetermined task.

In accordance with this configuration, since the user moves the plurality of the input devices using the plurality of the body parts, the contribution to improvement of the coordination ability of the human is anticipated.

In the above coordination training apparatus in accordance with the fourth aspect and in the above working memory training apparatus in accordance with the fifth to seventh aspects, said detecting unit includes an acceleration sensor, a gyroscope, a tilt sensor, a magnetic sensor, or a vibration sensor, or an arbitrary combination thereof. In accordance with this configuration, it is possible to easily detect the input operation of the user.

### BRIEF DESCRIPTION OF DRAWINGS

The novel features of the invention are set forth in the appended claims. The invention itself, however, as well as other features and advantages thereof, will be best understood by reading the detailed description of specific embodiments in conjunction with the accompanying drawings.

FIG. 1 is a block diagram showing an overall configuration of an information processing system in accordance with an embodiment of the present invention.

FIG. 2 is a perspective view showing an adapter 5 and a cartridge 3 of FIG. 1.

FIG. 3 is a perspective view showing input devices (rackets) RK1 and RK2 of FIG. 1.

FIG. 4 is a view showing an example of a menu selection screen as displayed on a television monitor 100 of FIG. 1.

FIG. 5 is a view showing an example of a response test screen as displayed on the television monitor 100 of FIG. 1.

FIG. 6 is a view showing an example of a task screen for a first memory test as displayed on the television monitor 100 of FIG. 1.

FIG. 7 is a view showing an example of an input screen for the first memory test as displayed on the television monitor 100 of FIG. 1.

FIG. 8 is a view showing an example of a task screen for a second memory test as displayed on the television monitor 100 of FIG. 1.

FIG. 9 is a view showing an example of a task screen for a third memory test as displayed on the television monitor 100 of FIG. 1.

FIG. 10 is a view showing an example of a task screen for a judgment test as displayed on the television monitor 100 of FIG. 1.

FIG. 11 is a view showing an example of a task screen for a first comparison-faculty test as displayed on the television monitor 100 of FIG. 1.

FIG. 12 is a view showing an example of a task screen for a second comparison-faculty test as displayed on the television monitor 100 of FIG. 1.

FIG. 13 is a view showing an example of a task screen for a third comparison-faculty test as displayed on the television monitor 100 of FIG. 1.

FIG. 14 is a block diagram showing electrical construction of the adapter 5 of FIG. 1.

FIG. 15 is a block diagram showing electrical construction of the cartridge 3 of FIG. 1.

FIG. 16 is a circuit diagram showing the racket RK of FIG. 3.

FIG. 17(a) is a transition diagram showing a coordination training process of a multimedia processor 91 of FIG. 15. FIG. 17(b) is a transition diagram showing a working memory training process of the multimedia processor 91 of FIG. 15.

FIG. 18 is a flowchart showing entire operation of the multimedia processor 91 of FIG. 15.

FIG. 19 is the flowchart showing a process of the response test of FIG. 5.

FIG. 20 is a flowchart showing a first part of a process of the first memory test of FIGS. 6 and 7.

FIG. 21 is a flowchart showing a latter part of the process of the first memory test of FIGS. 6 and 7.

FIG. 22 is a flowchart showing a first part of a process of the second memory test of FIG. 8.

FIG. 23 is a flowchart showing a first part of a process of the third memory test of FIG. 9.

FIG. 24 is a flowchart showing a process of the judgment test of FIG. 10.

FIG. 25 is a flowchart showing a first part of a process of the first comparison-faculty test of FIG. 11.

FIG. 26 is a flowchart showing a latter part of the process of the first comparison-faculty test of FIG. 11.

FIG. 27 is a flowchart showing a first part of a process of the second comparison-faculty test of FIG. 12.

FIG. 28 is an explanatory view for showing a modification of the embodiment in accordance with the present invention.

FIG. 29 is a perspective view showing an input device 1003L or 1003R of FIG. 28.

FIG. 30 is a view showing appearance of the input devices 1003L and 1003R of FIG. 28 which are worn on left and right hands respectively.

FIG. 31 is a view showing electrical construction of an information processing apparatus 1001 of FIG. 28.

FIG. 32 is a view showing another example of an input device employable in an information processing system of FIG. 28.

### BEST MODE FOR CARRYING OUT THE INVENTION

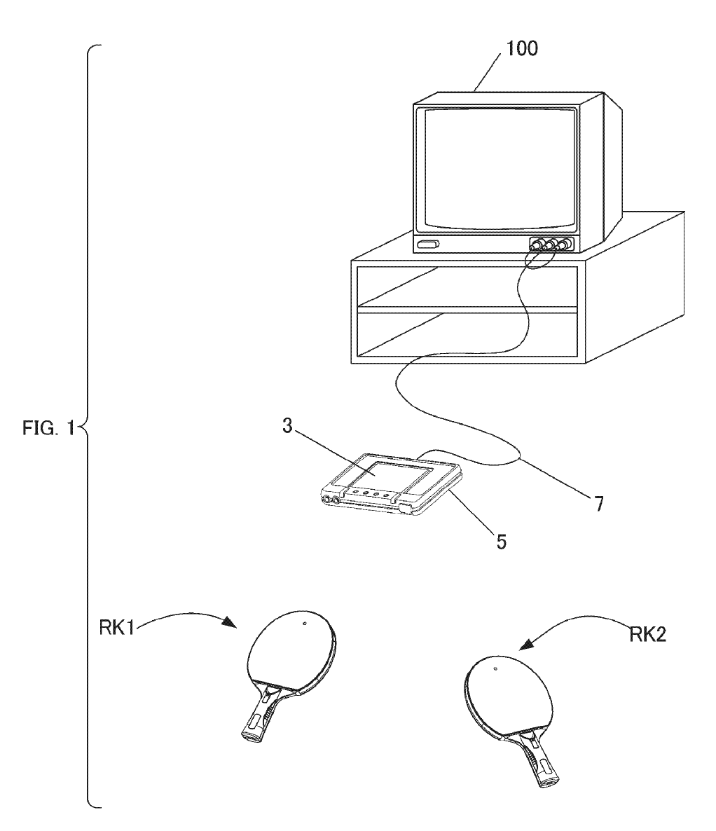

In what follows, an embodiment of the present invention will be explained in conjunction with the accompanying drawings. Meanwhile, like references indicate the same or functionally similar elements throughout the respective drawings, and therefore redundant explanation is not repeated. FIG. 1 is a block diagram showing overall configuration of an information processing system in accordance with an embodiment of the present invention. As shown in FIG. 1, the information processing system is provided with input devices RK1 and RK2, an adapter 5, a cartridge 3, and a television monitor 100. The cartridge 3 is inserted into the adapter 5. Also, the adapter 5 is coupled with the television monitor 100 by an AV cable 7.

The two input devices RK1 and RK2 imitate a shape of a table tennis racket respectively. Accordingly, in what follows, the input devices RK1 and RK2 are referred to as the rackets RK1 and RK2 respectively. Also, the rackets RK1 and RK2 are generally referred to as the “rackets RK” in the case where they need not be distinguished.

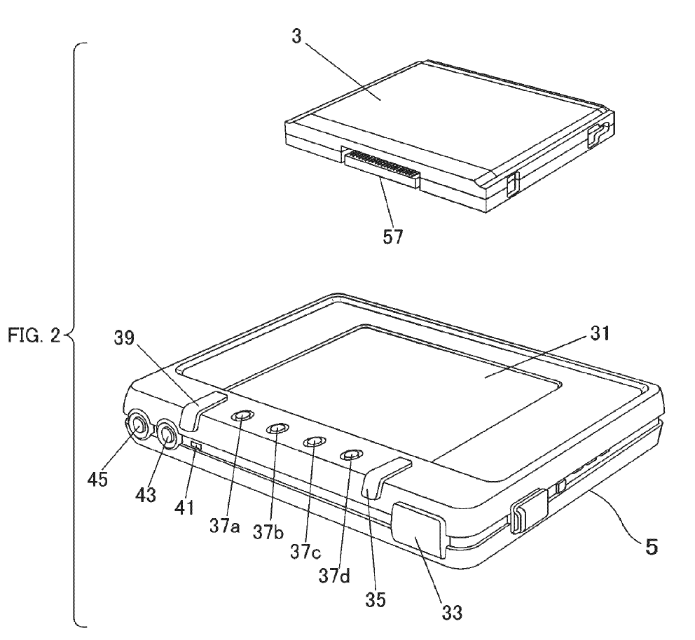

FIG. 2 is a perspective view showing the adapter 5 and the cartridge 3 of FIG. 1. As shown in FIG. 2, the adapter 5 has a flat rectangular parallelepiped shape with an upper face, a lower face, right and left side faces, and front and back faces. The adapter 5 is provided with a power supply switch 45, a reset switch 43 and a power lamp 41 on the front face in the left hand side, and an infrared filter 33 on the front face in the right hand side. This infrared filter 33 is a filter capable of cutting light rays except infrared rays and selectively transmitting infrared rays, and an infrared sensor (constituting an IR receiver circuit 71 to be described below) is located behind of this infrared filter 33. In addition, arrow keys 37a to 37d are provided on the upper face of the adapter 1 in the vicinity of the front edge thereof. Furthermore, there are provided a cancel key 39 in the left hand side of the arrow key 37a and an enter key 35 in the right hand side of the arrow key 37d.

An opening is formed on the middle area of the upper face of the adapter 5 while a top plate 31 is disposed therein so that its upper face is approximately flush with the upper face of the adapter 5. Inside the adapter 5, there is an elevator mechanism which supports and urges upward the top plate 31 so that the upper face of the top plate 31 is located at the height as described above. The top plate 31 is supported to move up and down in the opening by this elevator mechanism.

The cartridge 3 has a flat rectangular parallelepiped shape and implements a multimedia processor 91, a memory 93 and so on to be described below. There is provided a connector 57 including terminals t1 to t24 to be described below in the front of the cartridge 3. The cartridge 3 can be connected to the adapter 5 by placing and pushing down the cartridge 3 on the top plate 31, and sliding the cartridge 3 toward the front face (refer to FIG. 1). In this way, the connector 57 of the cartridge 3 is electrically connected with a connector 32 of the adapter 5 to be described below.

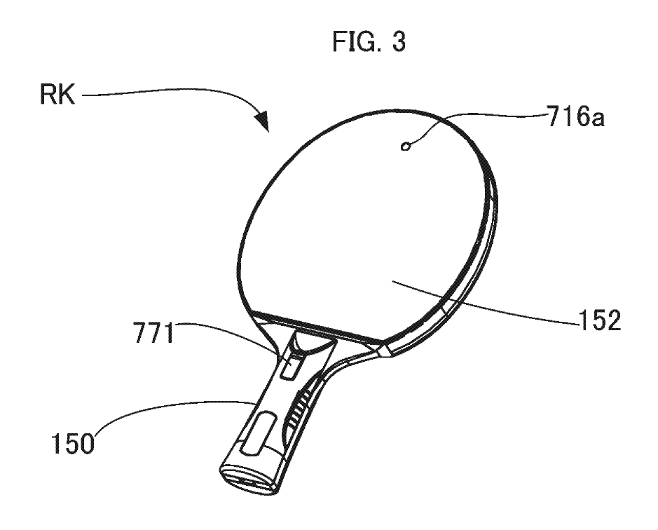

FIG. 3 is a perspective view showing the racket RK of FIG. 1. As shown in FIG. 3, the racket RK comprises a blade 152 and a grip 150. Infrared light emitting diodes 716a and 716b (cannot be shown in the figure) are exposed at the both faces of the blade 152. Also, although an infrared light emitting diode 716c cannot be shown in the figure, the infrared light emitting diode 716c is exposed at the top of the blade 152 on the periphery of the blade 152. The grip 150 is provided with a switch 771 in the vicinity of the neck.

Next, with reference to figures showing the screens displayed on the television monitor 100 by the multimedia processor 91 to be described below, processing of the multimedia processor 91 will be described.

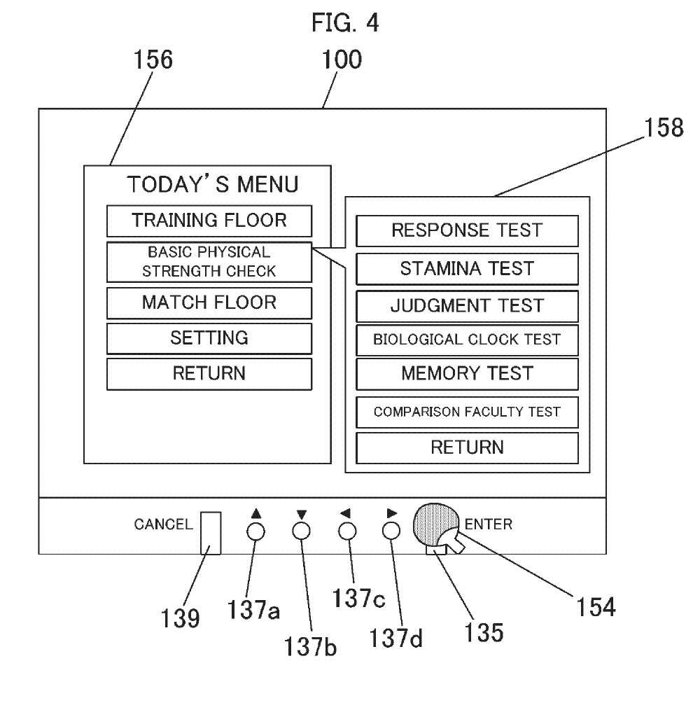

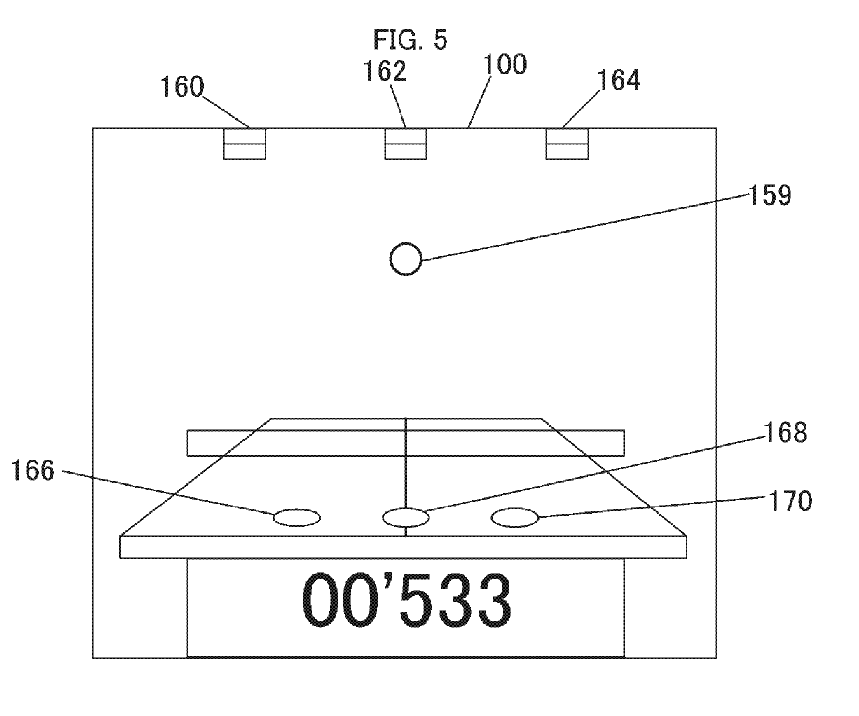

FIG. 4 is a view showing an example of a menu selection screen as displayed on the television monitor 100 of FIG. 1. As shown in FIG. 4, the multimedia processor 91 displays the menu selection screen on the television monitor 100. The menu selection screen includes a menu 156. In the example of the figure, an item “Basic Physical Strength Check” of the menu 156 is selected, and a submenu 158 related to the item “Basic Physical Strength Check” is displayed. In the present embodiment, processing of each test listed on the submenu 158 will be described.

A cancel key object 139, arrow key objects 137a to 137d, and an enter key object 135 are displayed along the bottom edge of the menu selection screen. The cancel key object 139, the arrow key objects 137a to 137d, and the enter key object 135 corresponds to the cancel key 39, the arrow keys 37a to 37d, and the enter key 35 respectively, and have shape and form imitating the corresponding one of them respectively. In what follows, the cancel key object 139, the arrow key objects 137a to 137d, and the enter key object 135 are sometimes called as the key object 139, the key objects 137a to 137d, and the key object 135 respectively.

Also, a cursor 154 is displayed so as to overlap with any one of the key objects 139, 137a to 137d, and 135. Each time a user swings the racket RK, the cursor 154 moves to the right-hand key object. However, in the case where the cursor 154 overlaps with the key object 135, when the racket RK is swung, the cursor 154 moves to the key object 139.

When the user presses the switch 771 of the racket RK, the multimedia processor 91 performs the same process as when the key of the adapter 5 corresponding to the key object with which the cursor 154 overlaps at that time is pressed. This point will be described with examples.

For example, in the case where the cursor 154 overlaps with the key object 137a, when the switch 771 of the racket RK is pressed, a selection area of the menu screen moves upward. In the case where the selection area is located at the item “Match Floor” of the menu 156, the selection area moves in order of the item “Match Floor”, the item “Basic Physical Strength Check”, and an item “Training Floor” each time when the switch 771 is pressed. Furthermore, in the case where the racket RK is swung and whereby the cursor 154 moves to the key object 137b, when the switch 771 is pressed, the selection area moves in order of the item “Training Floor”, the item “Basic Physical Strength Check”, the item “Match Floor”, and so on. In this way, operation for selecting each item listed on the menu 156 is performed.

In the example of the figure, since the selection area is located at the item “Basic Physical Strength Check” of the menu 156, the relevant submenu 158 is displayed. In this case, when the cursor 154 overlaps with the key object 135 followed by pressing the switch 771, selection of the item “Basic Physical Strength Check” is fixed, and then the selection area moves to the submenu 158. Subsequently, each item of the submenu 158 is selected and fixed in the same manner as the selecting operation and the fixing operation of each item of the menu 156.

As described in detail below, when the user actually swings the racket RK in a real space, an infrared ray signal corresponding to an acceleration correlated signal from a piezoelectric device 720 (as described below) is transmitted to an IR receiver circuit 71 (as described below) of the adapter 5 by the infrared light emitting diodes 716a to 716c. Then, the IR receiver circuit 71 digital-demodulates the received infrared ray signal, and then outputs it to the cartridge 3 as connected. The multimedia processor 91 of the cartridge 3 receives this signal and whereby can detect that the racket RK is swung.

In the case where the switch 771 of the racket RK is pressed, the multimedia processor 91 can detect ON and OFF states of the switch 771 in the same manner.

A response test will be described. When an item “Response Test” is selected and fixed in the submenu 158 of FIG. 4, the multimedia processor 91 performs processing of the response test. First, the multimedia processor 91 displays an explanation such as “Hit back balls shot from the upside and the bottom side of the screen as quickly as possible.” on the television monitor 100. Next, the multimedia processor 91 displays a word such as “READY?” on the television monitor 100. Subsequently, the multimedia processor 91 displays a response test screen.

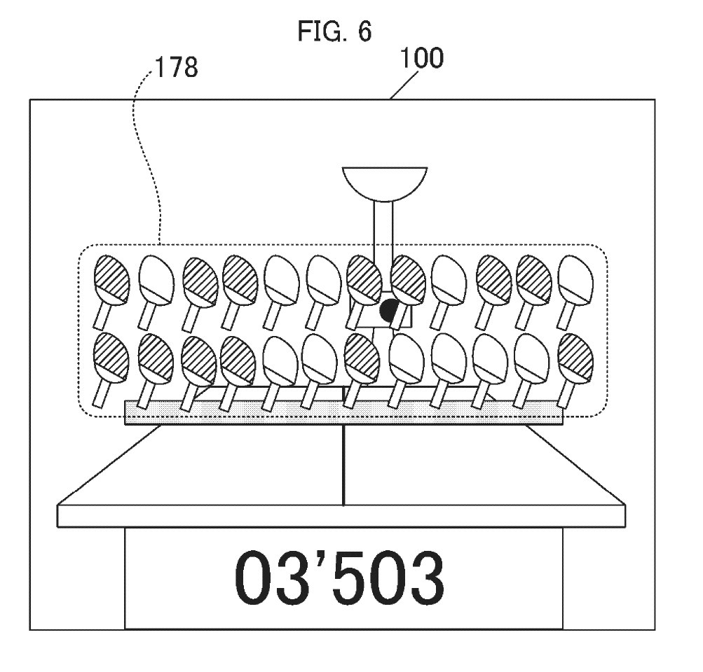

FIG. 5 is a view showing an example of the response test screen as displayed on the television monitor 100 of FIG. 1. Referring to FIG. 5, the response test screen includes shooting openings 160, 162, 164, 166, 168 and 170. Then, the multimedia processor 91 shoots a ball 159 from any one of the shooting openings. A counter in the bottom area of the screen indicates “00′ 000” at the point of time of the shoot, and starts to count time from the point of time of the shoot of the ball 159. The multimedia processor 91 moves the ball 159 at a fixed velocity vertically downward when shooting the ball 159 from any one of the shooting openings 160, 162 and 164. On the other hand, the multimedia processor 91 moves the ball 159 at a fixed velocity vertically upward when shooting the ball 159 from any one of the shooting openings 166, 168 and 170. Incidentally, the ball 159 can have acceleration.

The multimedia processor stops the counter in the bottom are of the screen at the point of time at which the user swings the racket RK, and whereby time from the shoot of the ball 159 to the swing of the racket RK is indicated.

Since the multimedia processor 91 shoots the ball 159 in a random manner from any one of the shooting openings 160, 162, 164, 166, 168 and 170, it is possible to test the extent to which response to the ball 159 as shot is quick (the response test). Timing of shooting the ball 159 is not orderly but random. Because, if the timing of shooting is orderly, the user can predict the shoot of the ball 159. Incidentally, if the racket RK is swung before the shoot of the ball 159, a display of a premature start is performed.

Besides, the shooting opening may be provided only to the upside, or only to the bottom side. Also, the number of the shooting openings may be any number which is more than or equal to one.

Next, a stamina test will be described. When an item “Stamina Test” is selected and fixed in the submenu 158 of FIG. 4, the multimedia processor 91 performs processing of the stamina test. First, the multimedia processor 91 displays letter string such as “Continue to swing the racket with short quick steps.” and letter string such as “Time Limit 20 seconds” on the television monitor 100. Next, the multimedia processor 91 displays a word such as “READY?” on the television monitor 100. Subsequently, the multimedia processor 91 displays a time counter which performs a countdown from 20 seconds and a score counter on the television monitor 100.

A value of the score counter depends on the number of times and the strength of swinging the racket RK. The details are as follows. The multimedia processor 91 determines the strength of the swing of the racket RK in three steps of a strong level, a medium level and a weak level. Since the racket RK transmits the infrared ray signal corresponding to the acceleration correlated signal at the time when it is swung to the multimedia processor 91 via the adapter 5, the multimedia processor 91 can classifies the acceleration of the racket RK into any one of the strong level, the medium level and the weak level. For example, it is assumed that 3 points, 2 points and 1 point are assigned to the strong level, the medium level and the weak level respectively. Since any one of them is selected each time when the racket RK is swung, it is possible to accumulate the point(s) to obtain a score, and whereby the score is displayed in real time on the score counter. Meanwhile, a score to be displayed may be the number of times of swinging the racket RK. Also, calorie consumption (referred to as “unit calorie consumption”) is preliminarily measured in each case of the strong level, the medium level and the weak level when a human swings the racket RK. Then, it is also possible to calculate calorie consumption during a test period by classifying the acceleration into any one of the strong level, the medium level and the weak level each time when the user swings the racket RK, and accumulating the corresponding unit calorie consumption.

This stamina test allows the user to know his/her own stamina which indicates how strongly and quickly he/she can continue to swing within the limited time.

Next, a memory test will be described. When an item “Memory Test” is selected and fixed in the submenu 158 of FIG. 4, the multimedia processor 91 performs processing of the memory test. First, the multimedia processor 91 displays letter string such as “Hold the 1P racket and the 2P racket with the left hand and the right hand respectively.” and letter string such as “Order of swinging both the rackets will be displayed on the next screen. Then, memorize it.” on the television monitor 100. The 1P racket corresponds to the racket RK1 and the 2P racket corresponds to the racket RK2. Next, the multimedia processor 91 displays a word such as “READY?” on the television monitor 100. Subsequently, the multimedia processor 91 displays a task screen.

In the present embodiment, the memory test includes a first memory test, a second memory test, and a third memory test. In what follows, task screens thereof will be described in series.

FIG. 6 is a view showing an example of the task screen for the first memory test as displayed on the television monitor 100 of FIG. 1. Referring to FIG. 6, this task screen includes a task displaying area 178. A total of 24 racket objects are displayed in two lines in the task displaying area 178. The area having hatched lines from bottom left to top right of the blade part of the racket object represents a red color, and the white area of the blade part of the racket object represents a blue color. The face of the blade of the racket RK1 of FIG. 1 is red, and therefore the racket object whose blade part is red represents the racket RK1. Also, the face of the blade of the racket RK2 of FIG. 1 is blue, and therefore the racket object whose blade part is blue represents the racket RK2.

Color and arrangement of the racket objects in the task displaying area 178 represents which of the rackets RK1 and RK2 must be swung in what order. That is to say, more specific description is as follows.

The leftmost racket object on the upper line in the task displaying area 178 is first, and the order becomes larger toward the right side. Then, the rightmost racket object on the lower line, which is next to the rightmost racket object on the upper line which is twelfth, is thirteenth, and the order becomes larger toward the right side. In addition, the color of the racket object indicates which of the rackets RK1 and RK2 the user must swing.

In the first memory test, form and order of the racket which the user must swing are indicated from a first to a twenty fourth at a time by the twenty four racket objects each of which has either the red color or the blue color in the task displaying area 178.

A counter is provided to the bottom area of the screen, and the multimedia processor 91 starts to count time from the point of time of displaying the racket objects in the task displaying area 178. When a predetermined time (e.g., 10 seconds) elapses after displaying the racket objects in the task displaying area 178, the multimedia processor 91 returns the color of the racket objects in the task displaying area 178 to a neutral state (the yellow color), and then displays a next screen. The predetermined time is a time which is given to the user to memorize the order of swinging the rackets RK1 and RK2.

The multimedia processor 91 displays letter string such as “Hit back the balls one by one by swing the 1P racket or the 2P racket in order which you have memorized now.” on the television monitor 100. Next, the multimedia processor 91 displays an input screen.

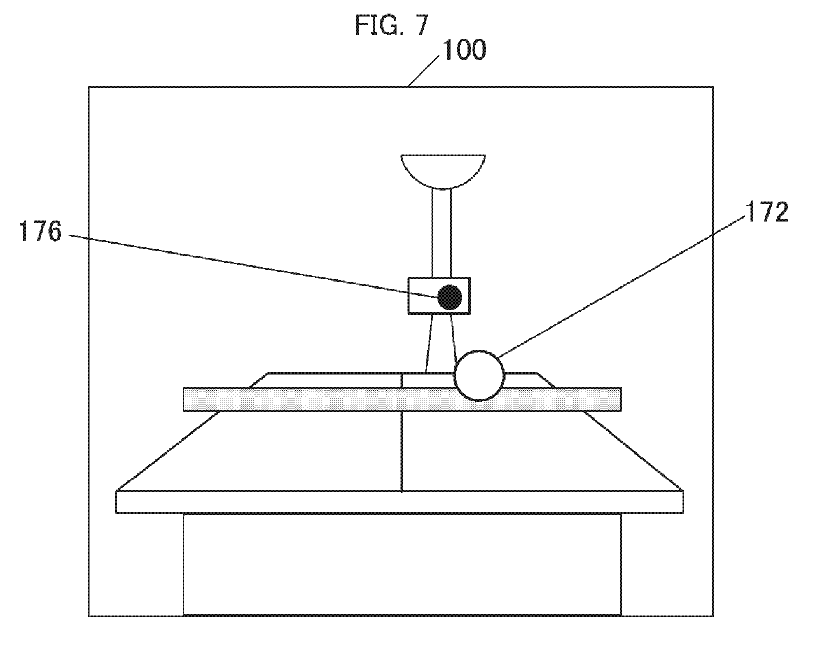

FIG. 7 is a view showing an example of the input screen for the first memory test as displayed on the television monitor 100 of FIG. 1. As shown in FIG. 7, this input screen includes a shooting portion 176, and the multimedia processor 91 shots the balls 172 with the same color in sequence at a prescribed time interval from the shooting portion 176.

The user hits back the balls 172 by swinging the racket RK1 or RK2 in the order which the user has memorized. Since the multimedia processor 91 can distinguish which racket is swung based on a specified bit included in the infrared ray signal as output from each of the rackets RK1 and RK2, the multimedia processor 91 can determined whether or not the rackets RK1 and RK2 are swung in the order indicated in the task displaying area 178. The multimedia processor 91 ends the present test at the point of time at which the user mistakes the order of the swings, and displays a result representing to what number the rackets RK1 and RK2 are swung in the prescribed order. In this case, the multimedia processor 91 determines either a missed swing or a hit on the basis of the timing of displaying the ball 172 and the timing of receiving the input from the racket RK1 or RK2, and generates images where the ball 172 is hit back if it is the hit.

Next, the second memory test will be described. The form and the order of the racket which the user must swing are indicated at a time in the first memory test. In contrast, in the second memory test, the form and the order of the racket which the user must swing are indicated in series from earlier one. In what follows, different points will be mainly described.

The twenty four racket objects indicating the neutral state are displayed in the task displaying area 178 at the point of time at which the task screen for the second memory test is displayed. Incidentally, in the same manner as described above, processing of counting a time period for memory is started from the point of this time. For example, the blade parts of the racket objects indicating the neutral state are represented by a yellow color. In the next figure, the yellow color of the blade part of the racket object is represented by crossed hatched lines.

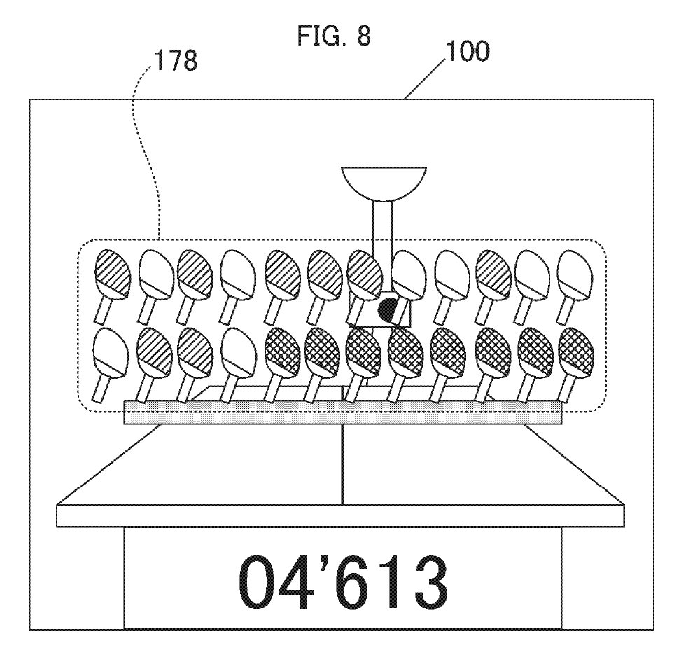

FIG. 8 is a view showing an example of the task screen for the second memory test as displayed on the television monitor 100 of FIG. 1. Referring to FIG. 8, the color of each racket object is changed to either the red color indicating the racket RK1 or the blue color indicating the racket RK2 in series from the leftmost racket object toward the rightmost racket object on the upper line in the task displaying area 178, and then, after reaching the right end, the color of each racket object is changed to either the red color indicating the racket RK1 or the blue color indicating the racket RK2 in series from the leftmost racket object toward the rightmost racket object on the lower line.

As described above, since the form and the order of the racket which the user must swing are not indicated at a time but in series, it is more difficult for the user to memorize. Therefore, degree of difficulty of the second memory test is higher than that of the first memory test. Incidentally, processing after displaying the task screen is same as that of the first memory test, and therefore description thereof is omitted.

Next, the third memory test will be described. The form and the order of the racket which the user must swing are indicated at a time in the first memory test, and the form and the order of the racket which the user must swing are indicated in series from earlier one in the second memory test. However, in the third memory test, while the form and the order of the racket which the user must swing are indicated in series from earlier one, when a prescribed time elapses from the start of the indication by the one racket object about the form and order of the racket, the one racket object is returned to the neutral state, and subsequently the indication by the next one racket object about the form and the order of the racket is performed. This process is repeated to the last order. In what follows, different points will be mainly described.

The twenty four racket objects indicating the neutral state are displayed on the task displaying area 178 at the point of time at which the task screen for the third memory test is displayed. This point is same as the second memory test. The processing of counting the time period for the memory is also started at the point of this time.

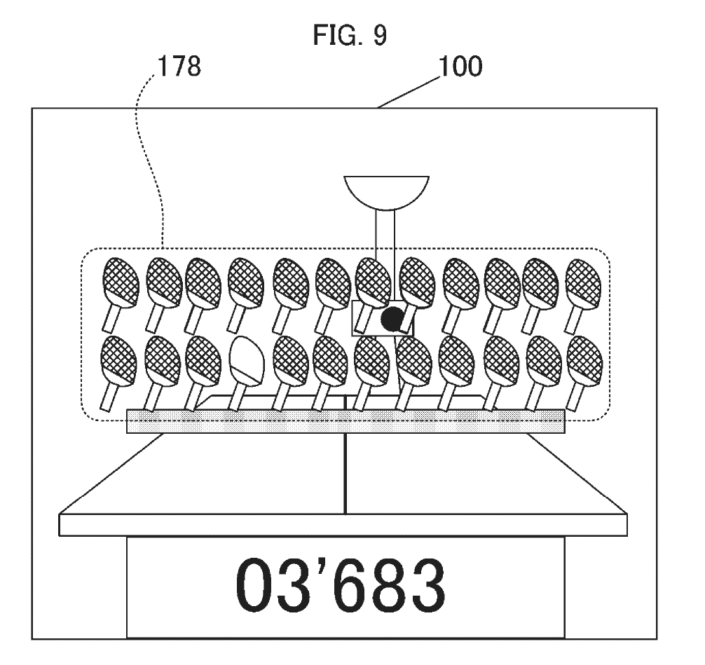

FIG. 9 is a view showing an example of the task screen for the third memory test as displayed on the television monitor 100 of FIG. 1. Referring to FIG. 9, in the third memory test, the color of the racket objects is changed to either the red color indicating the racket RK1 or the blue color indicating the racket RK2 in series from the leftmost racket object toward the rightmost racket object on the upper line of the task displaying area 178, and then, after reaching the right end, the color of the racket objects is changed to either the red color indicating the racket RK1 or the blue color indicating the racket RK2 in series from the leftmost racket object toward the rightmost racket object on the lower line.

However, in the third memory test, the racket object is returned to the neutral state again after a prescribed time (e.g., two seconds) elapses from when the racket object is changed from the neutral state to either the red color or the blue color. That is, the form and the order of the racket which the user must swing are indicated for every prescribed time over twenty-four times, and therefore the plurality of the racket objects cannot simultaneously become the red color or the blue color. FIG. 9 shows an example at the point of time at which the form of the racket which the user should swing in the sixteenth order is shown. After returning the sixteenth racket object to the neutral state, the seventeenth racket object which is arranged in the left side thereof is changed to either the red color or the blue color.

As described above, since the time period when the form and the order of the racket which the user must swing are indicated is short, it is further more difficult to memorize. Therefore, the degree of the difficulty of the third memory test is higher than those of the first and second memory tests. Incidentally, the processing after displaying the task screen is same as that of the first memory test, and therefore the description thereof is omitted.

While the form and the order are indicated in units of one racket object in the third memory test, for example, it is also possible to adjust the degree of the difficulty by indicating the form and the order in units of “N” (“N” is one or more integer) racket objects. As “N” becomes lager, the time period for the memory is longer, and therefore the degree of the difficulty becomes lower. In this case, “N” racket objects may be displayed at a time, or in series in the same manner as the second memory test.

Next, a judgment test will be described. When an item “Judgment Test” is selected and fixed in the submenu 158 of FIG. 4, the multimedia processor 91 performs processing of the judgment test. First, the multimedia processor 91 displays letter string such as “Hit back the ball having a color named by a word.” on the television monitor 100. Next, the multimedia processor 91 displays a word such as “READY?” on the television monitor 100. Subsequently, the multimedia processor 91 displays a task screen for the judgment test.

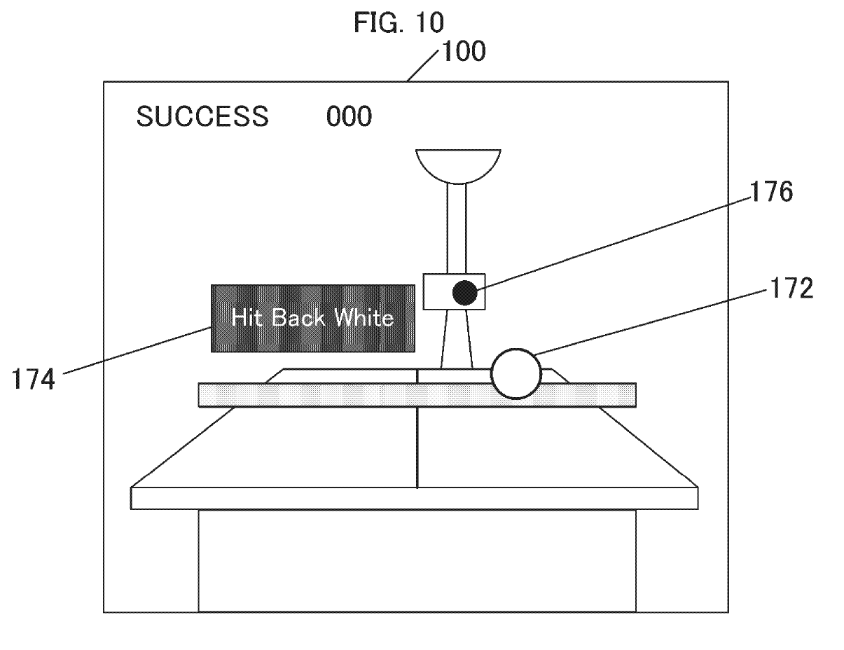

FIG. 10 is a view showing an example of the task screen for the judgment test as displayed on the television monitor 100 of FIG. 1. Referring to FIG. 10, this screen includes the shooting portion 176 and an indicating portion 174. The multimedia processor 91 shots the ball 172 filled with any one of the red color, the blue color and the white color from the shooting portion 176 at a predetermined time interval. In addition, the multimedia processor 91 indicates the color of the ball 172 which the user must hit back with a word in the indicating portion 174 before shooting the ball 172 from the shooting portion 176. The user tries to hit back the ball 172 of the color named by the word by swinging the racket RK when the ball 172 of the color named by the word in the indicating portion 174 is shot. When the ball 172 of the color other than the color named by the word is hit back, it is failure.

In the present embodiment, the judgment test includes a higher level test, a middle level test and a primary level test.

In the primary level test, the multimedia processor 91 makes the color named by the word in the indicating portion 174 coincident with the color of the word itself. Accordingly, the user can recognize the color of the ball 172 which he/she must hit back on the basis of the color of the word itself as well as the word in the indicating portion 174.

In the middle level test, the multimedia processor 91 makes the color named by the word in the indicating portion 174 different from the color of the word itself. The indication by the word is correct indication, and the indication by the color of the word itself is feigned indication. Accordingly, since the user is deluded with the color of the word itself in the indicating portion 174, it becomes difficult to hit back the ball 172 having the color named by the word in the indicating portion 174. In this way, the degree of the difficulty of the middle level test is higher than that of the primary level test.

In the higher level test, the multimedia processor 91 makes the color named by the word in the indicating portion 174 different from the color of the word itself and the color to be indicated by voice. The indication by the word is correct indication, and the indication by the color of the word itself and the indication by the voice are feigned indications. Accordingly, since the user is deluded with the color of the word itself in the indicating portion 174 and the voice, it becomes more difficult to hit back the ball 172 having the color named by the word in the indicating portion 174. That is, the primary level test does not include a factor with which determination is deluded, the middle level test includes one factor with which the determination is deluded, and the higher level test includes two factors with which the determination is deluded. Therefore, the degree of the difficulty of the higher level test is higher than those of the primary and middle level tests.

Since the multimedia processor 91 displays the number of times of success by the user on the television monitor 100, the user can recognize the number of times of the success.

Besides, process for adjusting the degree of the difficulty will be described. It is possible to indicate the color of the ball object 172 which the user must hit back with any one of a word(s), drawing, color and voice, or arbitrary combination thereof. Conversely, it is also possible to give feigned indication by any one of a word(s), drawing, color and voice, or arbitrary combination thereof. Accordingly, it is possible to easily adjust the degree of the difficulty by increasing or decreasing these factors which delude the user.

Also, as described above, although the ball object 172 is changed only the color thereof and shot, it is also possible to add any one of a word(s), drawing and voice, or arbitrary combination thereof to the ball object 172.

Further, while a subject of determination is the color in the above judgment test, it is not limited to the color, and it is possible to employ a word(s), drawing, voice or the like as the subject of the determination.

Next, a biological clock test will be described. When an item “Biological Clock Test” is selected and fixed in the submenu 158 of FIG. 4, the multimedia processor 91 performs processing of the biological clock test. First, the multimedia processor 91 displays letter string such as “Swing the racket at the time when you imagine that 10 seconds elapses after disappearance of a word “READY?”.” on the television monitor 100. Next, the multimedia processor 91 displays the word such as “READY?” on the television monitor 100. The multimedia processor 91 starts to count time from the point of time of disappearance of the word “READY?”.

Then, the multimedia processor 91 stops to count at the point of time at which the user swings the racket, and displays the indicated time (10 seconds) and the counted value (10 seconds measured by the biological clock of the user) on the television monitor 100.

The biological clock test allows the user to quantitatively recognize difference between the indicated time and the time by the biological clock. As the time to be indicated is longer, counting by the biological clock of the user becomes more difficult, and the time to be instructed is shorter, the counting by the biological clock of the user becomes easier. Therefore, it is possible to adjust the degree of the difficulty by the time to be indicated.

Next, a comparison-faculty test will be described. When an item “Comparison-Faculty Test” is selected and fixed in the submenu 158 of FIG. 4, the multimedia processor 91 performs processing of the comparison-faculty test. In the present embodiment, the comparison-faculty test includes a first comparison-faculty test, a second comparison-faculty test, and a third comparison-faculty test. In what follows, these will be described in series.

In the first comparison-faculty test, the multimedia processor 91 displays letter string such as “Which has the greater number of balls?” and letter string as “Swing the racket at the point of time at which you have an answer.” on the television monitor 100. Next, the multimedia processor 91 displays a task screen.

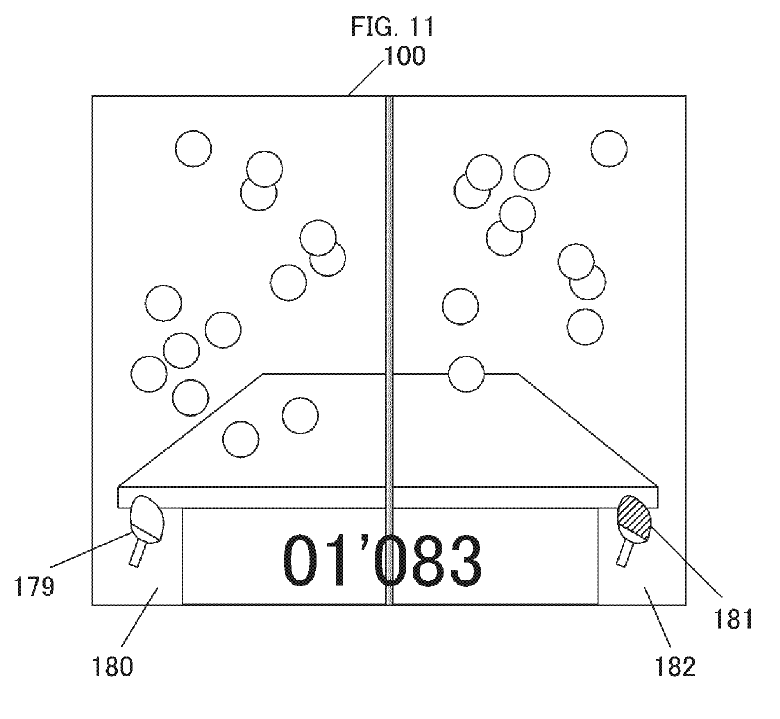

FIG. 11 is a view showing an example of the task screen for the first comparison-faculty test as displayed on the television monitor 100 of FIG. 1. Referring to FIG. 11, this screen is divided into left and right, and whereby consists of a left area 180 including the blue racket object 179 (white part) and a right area 182 including the red racket object 181 (hatched part). The left area 180 corresponds to the blue racket RK2 in FIG. 1 and the right area corresponds to the red racket RK1 in FIG. 1.

In FIG. 11, thirteen white balls are displayed in the left area 180, and eleven white balls are displayed in the right area 182. The user swings either one corresponding to the area where the number of balls is greater of the racket RK1 or RK2 in accordance with the above indication. The multimedia processor 91 starts to count time from the point of time of displaying the task screen, and displays the counted value on the television monitor 100. Then, the counting operation is stopped at the point of time when either the racket RK1 or RK2 is swung. Accordingly, the user can recognize how much time he/she can correctly answer. When answering incorrectly, the fact is displayed.

In the second comparison-faculty test, the multimedia processor 91 displays letter string such as “Which has the greater number of green balls?” and letter string such as “Swing the racket at the point of time at which you have an answer.” on the television monitor 100. Next, the multimedia processor 91 displays a task screen.

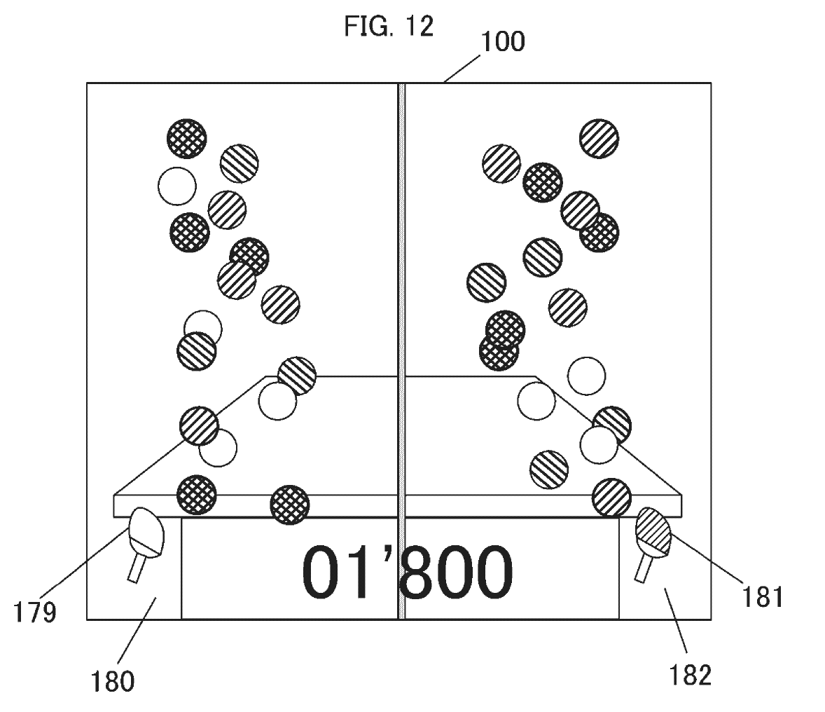

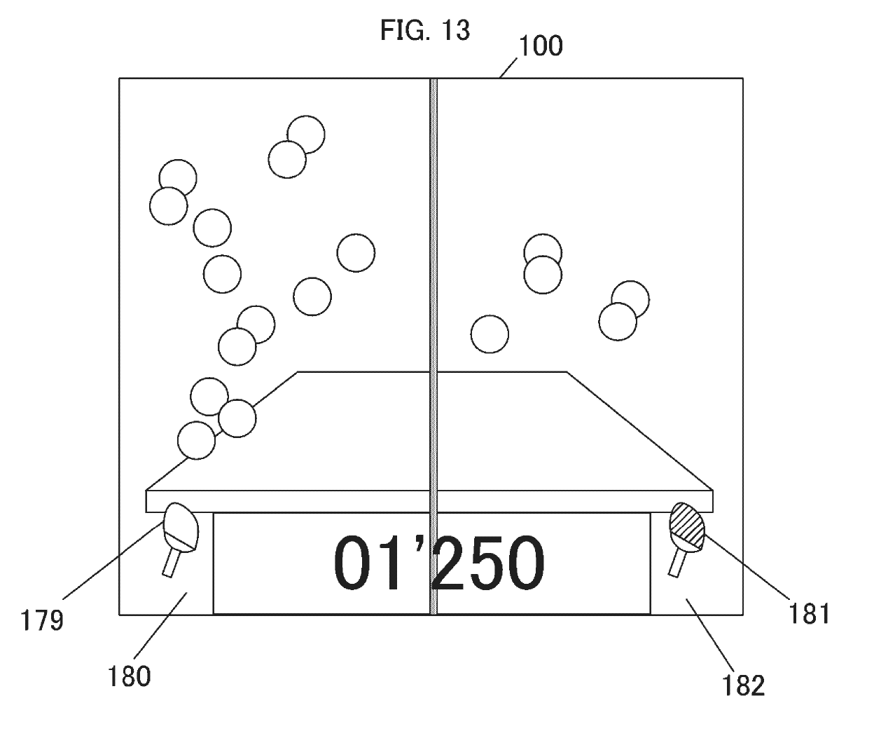

FIG. 12 is a view showing an example of the task screen for the second comparison-faculty test as displayed on the television monitor 100 of FIG. 1. Referring to FIG. 12, five green balls (shown by crossed hatched lines), three blue balls (shown by hatched lines from bottom right to top left), four red balls (shown by white color), and four yellow backs (shown by hatched lines from bottom left to top right) are displayed in the left area 180. On the other hand, four green balls (shown by crossed hatched lines), five blue balls (shown by hatched lines from bottom right to top left), three red balls (shown by white color), and three yellow balls (shown by hatched lines from bottom left to top right) are displayed in the right area 182. The user swings either one corresponding to the area where the number of the green balls is greater of the racket RK1 or RK2 in accordance with the above indication. The multimedia processor 91 starts to count time from the point of time of displaying the task screen, and displays the counted value on the television monitor 100. Then, the counting operation is stopped at the point of time when either the racket RK1 or RK2 is swung. Accordingly, the user can recognize how much time he/she can correctly answer. When answering incorrectly, the fact is displayed.

In the third comparison-faculty test, the multimedia processor 91 displays letter string such as “Which has the balls whose number is closer to six?” and letter string such as “Swing the racket at the point of time at which you have an answer.” on the television monitor 100. Next, the multimedia processor 91 displays a task screen.

FIG. 13 is a view showing an example of the task screen for the third comparison-faculty test as displayed on the television monitor 100 of FIG. 1. Referring to FIG. 13, thirteen white balls are displayed in the left area 180, and five white balls are displayed in the right area 182. The user swings either one corresponding to the area where the number of balls is closer to six of the racket RK1 or RK2 in accordance with the above indication. The multimedia processor 91 starts to count time from the point of time of displaying the task screen, and displays the counted value on the television monitor 100. Then, the counting operation is stopped at the point of time when either the racket RK1 or RK2 is swung. Accordingly, the user can recognize how much time he/she can correctly answer. When answering incorrectly, the fact is displayed.

As described above, the comparison-faculty test measures how quickly the difference between the left area 180 and the right area 182 is detected. Incidentally, examples of parameters for changing the degree of the difficulty of the comparison-faculty test include the number of the balls, movement of the ball, the number of colors of the ball, size of the ball, and a moving velocity of the ball.

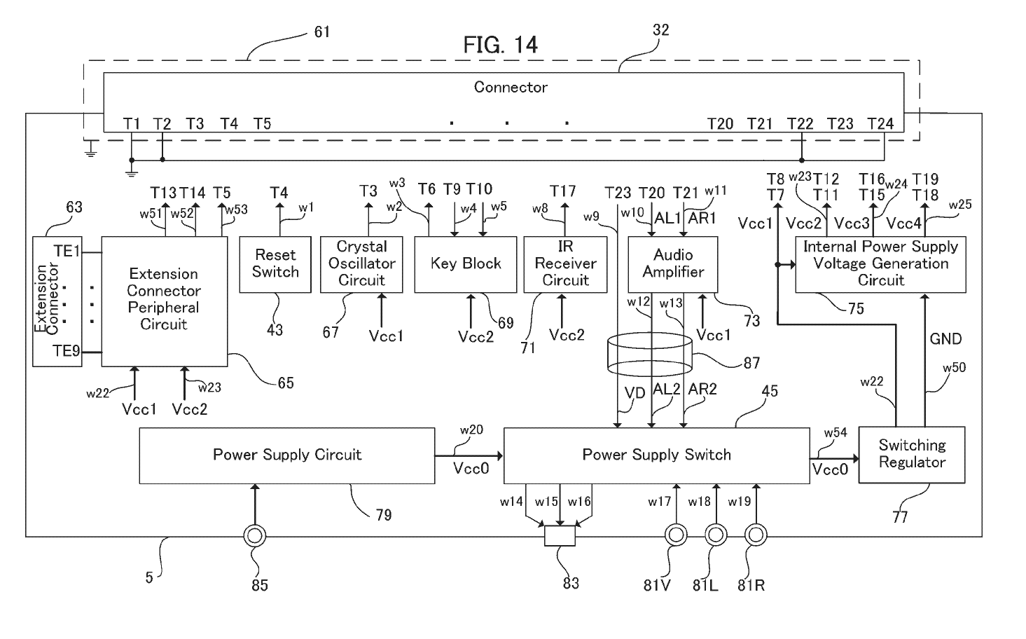

FIG. 14 is a block diagram showing electrical construction of the adapter 5. As shown in FIG. 14, this adapter 5 includes the connector 32, an extension connector 63, an extension connector peripheral circuit 65, the reset switch 43, a crystal oscillator circuit 67, a key block 69, the infrared signal receiver circuit (IR receiver circuit) 71, an audio amplifier 73, an internal power supply voltage generation circuit 75, a power supply circuit 79 comprising an AC/DC converter and the like, the power supply switch 45, a switching regulator 77, a power jack 85, an AV jack 83, a video jack 81V, a L channel audio jack 81L, and a R channel audio jack 81R. The connector 32 has 24 terminals T1 to T24 and is covered by a shield member 61 which is grounded. The terminals T1, T2, T22 and T24 of the connector 32 are grounded.

The AC voltage as supplied from a power cable (not shown in the figure) is supplied to the power supply circuit 79 through the power jack 85. The power supply circuit 79 converts the AC voltage as given to a DC voltage, which is then output to a line w20 as a power supply voltage Vcc0. When turned on, the power supply switch 45 connects the line w20 and a line w54 to give the switching regulator 77 the power supply voltage Vcc0, and gives the AV jack 83 a video signal “VD” from a line w9 and audio signals “AL2” and “AR2” from the lines w12 and w13 respectively through lines w14, w15 and w16. Accordingly, the video signal “VD” and the audio signals “AL2” and “AR2” are given to the television monitor 100 through the AV cable 7, while the television monitor 100 displays an images corresponding thereto with sounds corresponding thereto output from speakers (not shown in the figure).

On the other hand, when turned off, the power switch 45 connects lines w17, w18 and w19 to lines w14, w15 and w16 respectively. By this configuration, a video signal as input from the video jack 81V, an L channel audio signal as input from the L channel audio jack 81L and an R channel audio signal as input from the L channel audio jack 81R are given to the AV jack 83. Accordingly, the video signal and the audio signals as input from the jacks 81V, 81L and 81R are transferred to the television monitor 100 from the AV jack 83 through the AV cable 7. As thus described, when the power supply switch 45 is turned off, it is possible to output the video signal and the audio signals as input from an external device through the jacks 81V, 81L and 81R to the television monitor 100.

The switching regulator 77 receives the power supply voltage Vcc0 from the power supply circuit 79 through the line w54 when the power supply switch 45 is turned on, and generates a ground potential GND and the power supply voltage Vcc1 on the lines w50 and w22 respectively. On the other hand, when the power supply switch 45 is turned off, the switching regulator 77 does not receive the power supply voltage Vcc0, and thereby it does not generate the power supply voltage Vcc1.

The internal power supply voltage generation circuit 75 generates power supply voltages Vcc2, Vcc3 and Vcc4 respectively on the lines w23, w24 and w25 on the basis of the ground potential GND and the power supply voltage Vcc1 as supplied from the switching regulator 77. The line w22 is connected to the terminals T7 and T8 of the connector 32; the line w23 is connected to the terminals T11 and T12 of the connector 32; the line w24 is connected to the terminals T15 and T16 of the connector 32; and the line w25 is connected to the terminals T18 and T19 of the connector 32. It is assumed that Vcc0>Vcc1>Vcc2>Vcc3>Vcc4. Incidentally, when the power supply switch 45 is turned off, the power supply voltage Vcc1 is not generated, and thereby the power supply voltages Vcc1, Vcc2, Vcc3 and Vcc4 are not supplied to the cartridge 3 through the connector 32.

The audio amplifier 73 amplifies the R channel audio signal “AR1” as input through the line w11 which is connected to the terminal T21 and the L channel audio signal “AL1” as input through the line w10 which is connected to the terminal T20, and outputs the R channel audio signal “AR2” and L channel audio signal “AL2” as amplified to the lines w13 and w12 respectively. The line w9 for inputting the video signal “VD” to the power supply switch 45 is connected to the terminal T23 of the connector 32.

The lines w9, w12 and w13 are covered by a cylindrical ferrite 87 in order not to radiate electromagnetic waves therefrom.

The IR (infrared ray) receiver circuit 71, which includes the above infrared sensor, demodulates the digital modulated infrared signal as received, and outputs digital demodulated signal to the line w8. The line w8 is connected to the terminal T17 of the connector 32.

The key block 69 includes the cancel key 39, the direction keys 37a to 37d and the enter key 35 and is provided with a shift register (not shown in the figure). This shift register serves to convert parallel signals which are input from the respective keys 39, 37a to 37d and 35 and a terminal TE7 described below, into serial signals, and output the serial signals to the line w3. This line w3 is connected to the terminal T6 of the connector 32. In addition, the key block 69 is given a clock signal through the line w5 which is connected to the terminal T10 and a control signal through the line w4 which is connected to the terminal T9.

The crystal oscillator circuit 67 oscillates a clock signal at a predetermined frequency, and supplies the clock signal to the line w2. The line w2 is connected to the terminal T3 of the connector 32.

The reset switch 43 outputs a reset signal, which is used for resetting the system, to the line w1. The line w1 is connected to the terminal T4 of the connector 32.

The extension connector 63 is provided with first to ninth terminals (referred to as terminals TE1 to TE9 in the following description). The terminals TE2, TE4 and TE6 are connected to the terminals T13, T14 and T5 of the connector 32 respectively through the extension connector peripheral circuit 65. Accordingly, signals can be input from and output to the external device connected to the extension connector 63 through the terminals TE2, TE4 and TE6. The lines w4 and w5 are connected to the terminal TE9 and TE8 respectively. Accordingly, the external device connected to the extension connector 63 can receive the same clock signal as the key block 69 through the terminal TE8, and receive the same control signal as the key block 69 through the terminal TE9.

The terminals TE3 and TE5 are supplied respectively with the power supply voltages Vcc1 and Vcc2 through the extension connector peripheral circuit 65. Accordingly, the power supply voltages Vcc1 and Vcc2 can be supplied to the external device connected to the extension connector 63 through the terminals TE3 and TE5. The terminal TE1 is grounded. The terminal TE7 is connected to a predetermined input terminal of the above shift register included in the key block 69 through the extension connector peripheral circuit 65.

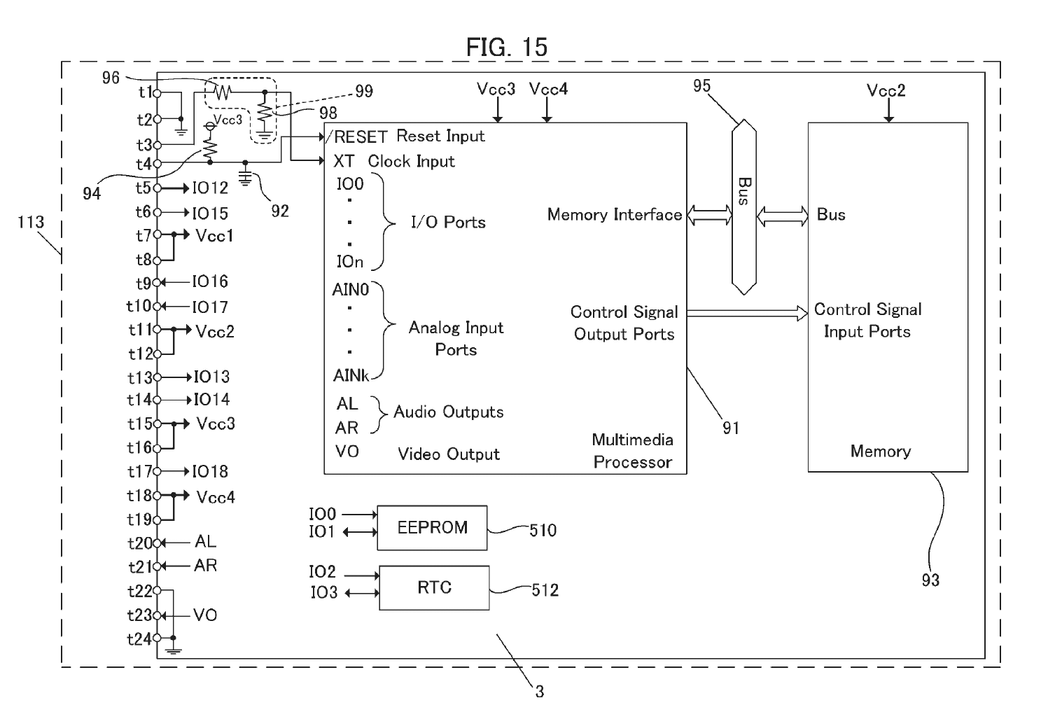

FIG. 15 is a block diagram showing electrical construction of the cartridge 3. As shown in FIG. 15, the cartridge 3 includes the multimedia processor 91, a memory 93, an EEPROM (electrically erasable programmable readonly memory) 510, an RTC (realtime clock) 512, terminals t1 to t24, a bus 95 (including a data bus and an address bus), and an amplitude setting circuit 99. The amplitude setting circuit 99 includes the resistors 96 and 98.

The multimedia processor 91 includes a reset input port /RESET for inputting a reset signal, a clock input port XT for inputting a clock signal “SCLK2”, an input/output ports (I/O ports) IO0 to IOn (“n” is a natural number, for example, n=23) for inputting/outputting data, analog input ports AIN0 to AINk (“k” is a natural number, for example, k=5) for inputting analog signals, audio output ports AL and AR for outputting audio signals “AL1” and “AR1”, a video output port VO for outputting a video signal “VD”, control signal output ports for outputting control signals (for example, a chip enable signal, an output enable signal, a write enable signal and so on), and a memory interface.

The memory 93 includes a bus (including an address bus and a data bus), and control signal input ports for inputting control signals (for example, a chip enable signal, an output enable signal, a write enable signal and so forth). This memory preliminarily stores programs for executing the above various tests, image data, sound data, and so on. The memory 93 may be, for example, a ROM (read only memory), a flash memory, or any appropriate memory.

The control signal output ports of the multimedia processor 91 are connected to the control signal input ports of the memory 93. The memory interface and the bus of the multimedia processor 91 are connected to the bus 95. In this case, the control signal output ports of the multimedia processor 91 include an OE output port for outputting an output enable signal, a CE output port for outputting a chip enable signal, a WE output port for outputting a write enable signal, and so forth. Also, the control signal input ports of the memory 93 include an OE input port connected to the OE output port of the multimedia processor 91, a CE input port connected to the CE output port of the multimedia processor 91, a WE input port connected to the WE output port of the multimedia processor 91, and so forth.

When receiving the chip enable signal, the memory 93 responds to the chip enable signal as the destination thereof to output a data signal in accordance with an address signal and the output enable signal which are given substantially at the same time as the chip enable signal. The address signal is input to the memory 93 through the address bus of the bus 95 while the data signal is input to the multimedia processor 91 through the data bus of the bus 95. Also, when receiving the chip enable signal, the memory 93 responds to the chip enable signal as the destination thereof to receive and write a data signal in accordance with an address signal and the write enable signal which are given substantially at the same time as the chip enable signal. The address signal is input to the memory 93 through the address bus of the bus 95 while the data signal is input to the memory 93 from the multimedia processor 91 through the data bus of the bus 95.

The EEPROM 510 is connected to the I/O ports IO0 and IO1 of the multimedia processor 91, and given a clock signal, read data and written data through the I/O ports by the multimedia processor 91. The RTC 512 serves to measure the time on the basis of the quartz oscillator (not shown in the figure) and generate time information which is given to the multimedia processor 91. The RTC 512 is connected to the I/O ports IO2 and IO3 of the multimedia processor 91, and given a clock signal by the multimedia processor 91, and gives the time information to the multimedia processor 91 through the I/O ports.

When the cartridge 3 is inserted into the adapter 5, the terminals t1 to t24 are connected to the terminals T1 to T24 of the connector 32 of the adapter 5 in a one-to-one correspondence. The terminals t1, t2, t22 and t24 are grounded. The terminal t3 is connected to the amplitude setting circuit 99. Namely, the resistor 96 of the amplitude setting circuit 99 is connected to the terminal t3 at one terminal thereof, and connected to the clock input port XT of the multimedia processor 91 and one terminal of the resistor 98 at the other terminal thereof. The other terminal of the resistor 98 is grounded. Namely, the amplitude setting circuit 99 is a resistive potential divider.

The clock signal “SCLK1” generated by oscillation of the crystal oscillator circuit 67 of the adapter 5 is input through the terminal t3 to the amplitude setting circuit 99 which then generates a clock signal “SCLK2” having an amplitude smaller than the clock signal “SCLK1” and outputs the clock signal “SCLK2” to the clock input port XT. In other words, the amplitude of the clock signal “SCLK2” is set to a value which is determined by the ratio between the resistor 96 and the resistor 98.

The terminal t4 is connected to the reset input port /RESET of the multimedia processor 91. Also, one terminal of the resistor 94 and one terminal of the capacitor 92 are connected to the line through which the reset input port /RESET is connected to the terminal t4. The other terminal of the resistor 94 is supplied with the power supply voltage Vcc2, and the other terminal of the capacitor 92 is grounded.

The terminals t5, t13 and t14 are connected respectively to the I/O ports IO12, IO13 and IO14 of the multimedia processor 91. Accordingly, the multimedia processor 91 can input/output signals from/to an external device connected to the extension connector 63 of FIG. 14 through the terminals t5, t13 and t14.

The power supply voltage Vcc1 is supplied from the terminals t7 and t8. The power supply voltage Vcc2 is supplied from the terminals t11 and t12. The power supply voltage Vcc3 is supplied from the terminals t15 and t16. The power supply voltage Vcc4 is supplied from the terminals t18 and t19. The power supply voltages Vcc3 and Vcc4 are supplied to the multimedia processor 91.

The terminals t6, t9, t10 and t17 are connected respectively to the I/O ports IO15, IO16, IO17 and IO18 of the multimedia processor 91. Accordingly, the multimedia processor 91 can receive a signal output from the key block 69 through the terminal t6. Also, the multimedia processor 91 can output a control signal to an external device connected to the extension connector 63 and the key block 69 through the terminal t9. Furthermore, the multimedia processor 91 can supply a clock signal to an external device connected to the extension connector 63 and the key block 69 through the terminal t10. Still further, the multimedia processor 91 can receive the output signal of the IR receiver circuit 71 through the terminal t17.

The terminals t20 and t21 are connected to the audio output ports AL and AR of the multimedia processor 91. The terminal t23 is connected to the video output port VO of the multimedia processor 91. Accordingly, the multimedia processor 91 can output the audio signals “AL1” and “AR1” to the audio amplifier 73 of the adapter 5 through the terminals t20 and t21, and output the video signal “VD” to the power supply switch 45 of the adapter 5 through the terminal t23.

Incidentally, the cartridge 3 is provided with a shield member 113. By virtue of the shield member 113, electromagnetic waves can be prevented, as much as possible, from leaking from the multimedia processor 91 and the like as external radiation.

The internal configuration of the multimedia processor 91 will be briefly explained. Although not shown in the figure, this multimedia processor 91 is provided with a central processing unit (referred to as the “CPU” in the following description), a graphics processing unit (referred to as the “GPU” in the following description), a sound processing unit (referred to as the “SPU” in the following description), a geometry engine (referred to as the “GE” in the following description), an external interface block, the above memory interface, a main RAM, and an A/D converter (referred to as the “ADC” in the following description) and so forth.

The CPU performs various operations and controls the overall system in accordance with the programs stored in the memory 93. The CPU performs the process relating to graphics operations, which are performed by running the program stored in the memory 93, such as the calculation of the parameters required for the expansion, reduction, rotation and/or parallel displacement of the respective objects and sprites and the calculation of eye coordinates (camera coordinates) and view vector. In this description, the term “object” is used to indicate a unit which is composed of one or more polygons and to which expansion, reduction, rotation and parallel displacement transformations are applied in an integral manner. Each object included in the screens shown in FIG. 4 to FIG. 13 as described above may be composed of the sprite (s), or the object (s).

The GPU serves to generate a three-dimensional image composed of polygons and sprites on a real time base, and converts it into an analog composite video signal. The SPU generates PCM (pulse code modulation) wave data, amplitude data, and main volume data, and generates analog audio signals from them by analog multiplication. The GE performs geometry operations for displaying a three-dimensional image. Specifically, the GE executes arithmetic operations such as matrix multiplications, vector affine transformations, vector orthogonal transformations, perspective projection transformations, the calculations of vertex brightnesses/polygon brightnesses (vector inner products), and polygon back face culling processes (vector cross products).

The external interface block is an interface with peripheral devices and includes programmable digital input/output (I/O) ports IO0 to IO23 of 24 channels. The ADC is connected to analog input ports AIN0 to AIN3 of 4 channels and serves to convert an analog signal, which is input from an analog input device through the analog input port, into a digital signal. The main RAM is used by the CPU as a work area, a variable storing area, a virtual memory system management area and so forth.

The memory interface serves to read data from the memory 93 and write data to the memory 93, respectively through the bus 95. In addition, the memory interface has also the DMA function.

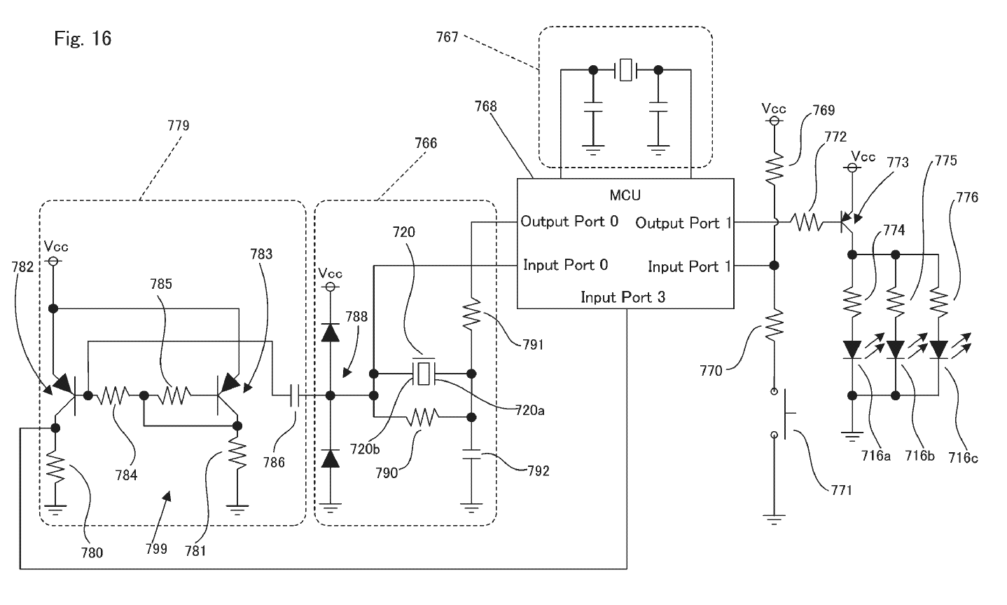

FIG. 16 is a circuit diagram showing the racket RK of FIG. 3. Referring to FIG. 16, the piezoelectric element 720 is included in the acceleration sensor circuit 766. Also, the MCU 768 is provided with an external crystal oscillator circuit 767 and operates in response to the clock signal generated by this crystal oscillator circuit 767. Then, the MCU 768 outputs a square wave signal from the output port 0, and applies the square wave signal to one electrode 720a of the piezoelectric element 720 through the resistor 791.

The electrode 720a of the piezoelectric element 720 is grounded through a capacitor 792. The other electrode 720b of the piezoelectric element 720 is connected to the input port 0 of the MCU 768 through a resistor 793 and connected to a diode circuit 788, so that the fluctuation of voltage is maintained within a constant range. Meanwhile, the two electrodes 720a and 720b of the piezoelectric element 720 are electrically separated from each other with a relatively high resistor 790.

The input port 1 of the MCU 768 is connected to the node between the resistor 769 and the resistor 770. The other terminal of the resistor 769 is connected to the power supply Vcc. The other terminal of the resistor 770 is connected to one terminal of the switch 771 while the other terminal of the switch 771 is grounded. If the switch 771 is opened, the node connected to the input port 1 is equal to the potential of the power supply Vcc. If the switch 771 is closed, a current flows from the power supply Vcc to the ground to pull down the potential of the node connected to the input port 1 to the potential determined by the voltage division between the resistor 769 and the resistor 770. With reference to the change in this potential, the MCU 768 can determine whether or not the switch 771 is conducting.

The output port 1 of the MCU 768 is connected to the base of the PNP transistor 773 through a resistor 772. The emitter of the transistor 773 is connected to the power supply Vcc while the collector thereof is connected to one terminals of resistors 774, 775, 776, 777 and 778. The other terminals of these resistors 774, 775 and 776 are connected to the respective infrared light emitting diode 716a to 716c as described above. It is possible to control the lighting of the infrared light emitting diodes 716a to 716c by the output from the output port 1.

When the square wave signal is applied to the electrode 720a of the piezoelectric element 720, a triangular wave signal is input to the input port 0 of the MCU 768 during the charging and discharging of the capacitor 792. However, the amplitude of the triangular wave signal (peak to peak) is determined by the diode circuit 788.

When the racket RK is in a stationary condition, i.e., not moved, the potential of the triangular wave signal does not change in its lowest level (minus). However, if the player moves the racket RK in the three-dimensional space, a voltage is induced within the piezoelectric element 720 by piezoelectric effect associated with the motion. This acceleration correlated voltage biases the triangular wave signal in the minus side.

Accordingly, when the racket RK is moved, the acceleration correlated voltage is generated in the piezoelectric element 720 in accordance with the magnitude of the displacement acceleration, and therefore the lowest level of the triangular wave signal as input to the input port 0 of the MCU 768 varies in accordance with the level of the acceleration correlated voltage. The MCU 768 converts the deviation of the lowest level of the triangular wave signal into acceleration data. In this case, the MCU 768 converts the acceleration data into one of four levels, i.e., the zeroth to third levels, and controls the infrared light emitting diodes 716a to 716c in accordance with the level. That is, the level information is transmitted instead of the acceleration data itself. The zeroth level is assigned to the acceleration data whose range is zero (the racket RK is not moved) to the first predetermined value, the first level is assigned to the acceleration data whose range is the first predetermined value to the second predetermined value, the second level is assigned to the acceleration data whose range is the second predetermined value to the third predetermined value, and the third level is assigned to the acceleration data which exceeds the third predetermined value. Incidentally, it is assumed that the first predetermined value<the second predetermined value<the third predetermined value. Also, when the acceleration data is the zeroth level, MCU 768 does not drive the infrared light emitting diodes 716a to 716c. That is, the information which indicates the zeroth level of the acceleration data is not transmitted. Accordingly, the multimedia processor 91 determines that the racket RK is not swung when MCU 768 does not transmit the level information, i.e., the infrared ray signal is not transmitted.

Also, the value “1” is preliminarily set to a specific input port of the MCU 768 of the racket RK1, and the value “0” is preliminarily set to a specific input port of the MCU 768 of the racket RK2. Therefore, MCU 768 can confirm which of the rackets RK1 and RK2 is the racket in which MCU 768 itself is implemented. Then, MCU 768 sets the value of the specific bit of the infrared ray signal in accordance with the value of the specific input port. The multimedia processor 91 can confirm from which racket the input is given by this specific bit.

By the way, a start-up circuit 779 is composed of a current mirror circuit 799 and a capacitor 786. This capacitor 786 has one terminal connected to the electrode 720b of the piezoelectric element 720 and the other terminal connected to the base of a PNP transistor 782. The emitters of PNP transistors 782 and 783 are connected to the power supply Vcc. The collectors of the PNP transistors 782 and 783 are connected to one terminals of resistors 780 and 781. The other terminals of the resistors 780 and 781 are grounded. Resistors 784 and 785 are connected between the base of the PNP transistor 782 and the base of the PNP transistor 783 in series. The connecting point between the resistor 784 and the resistor 785 is connected to the collector of the PNP transistor 783. Also, the collector of the PNP transistor 782 is connected to the input port 3 of the MCU 768.

In this case, for example, it is assumed that the resistors 784 and 785 have a resistance value of 1 MΩ, that the resistor 780 has a resistance value of 100 kΩ) and that the resistor 781 has a resistance value of 1 MΩ. The resistance values of the resistors 784 and 785 are set to be large in this manner. Also, the resistance value of the resistor 781 is larger than the resistance value of the resistor 780.

First, when the racket RK is not moved so that the piezoelectric element 720 generates no voltage, the MCU 768 does not output a square wave signal from the output port 0. In this case, the collector current of the PNP transistor 782 is equal to the collector current of the PNP transistor 783 while the resistance value of the resistor 780 is smaller than the resistance value of the resistor 781, and therefore the potential at the collector of the PNP transistor 782 is smaller than the potential at the collector of the PNP transistor 783 ( 1/10 in this example). Because of this, the input port 3 of the MCU 768 is given a low level signal, and therefore the MCU 768 stops outputting the square wave signal.

Then, when the racket RK is moved, the piezoelectric element 720 is oscillated so that a voltage is generated in response to the oscillation. In this case, when this voltage is generated in the minus direction, the base current of the PNP transistor 782 flows into the capacitor 786. Therefore, the base current of the PNP transistor 782 increases as compared to the case where the racket RK is not moved. Thereafter, the collector current of the PNP transistor 782 increases to pull up the potential of the collector terminal, so that a high level voltage is given to the input port 3 of the MCU 768. By this process, the MCU 768 starts outputting the square wave signal from the output port 0.

By the way, next, transition of processing which the multimedia processor 91 performs in order to provide the respective tests as described above will be described.

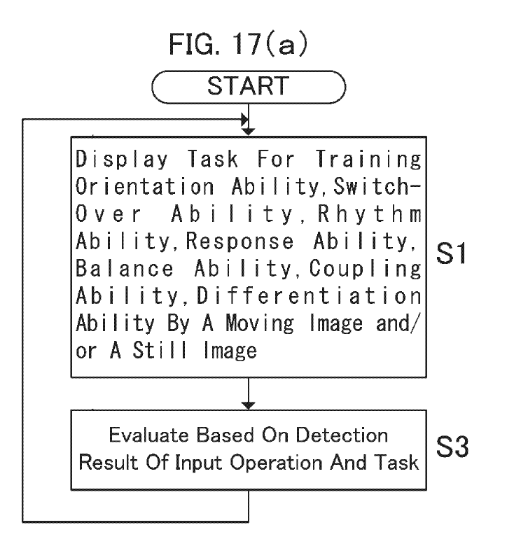

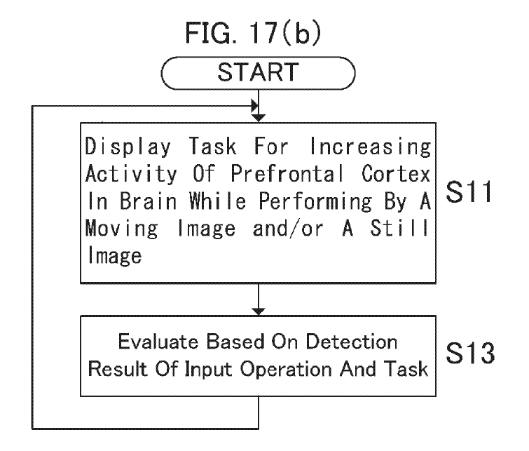

FIG. 17(a) is a transition diagram showing coordination training process of the multimedia processor 91 of FIG. 15. Referring to FIG. 17(a), in step S1, the multimedia processor 91 generates the pictures (e.g., see FIG. 5) and the voice which represent a task for training coordination ability (referred to as the “coordination training task” in the following description) based on the image data and the voice data stored in the memory 93 in accordance with the application program stored in the memory 93, and then outputs them to the television monitor 100. In this case, the pictures include a moving image, a still image, or combination thereof. Also, the coordination training task may be indicated with only the picture, only the voice, or the combination thereof. However, in the present embodiment, the tasks are mainly indicated with the pictures.

Referring to the document (Akito Azumane and Keiji Miyashita, “Motto motto undonoryoku ga tsuku mahou no houhou”, SHUFU-TO-SEIKATSUSHA LTD., Nov. 15, 2004), the coordination ability is defined as an ability to smoothly perform processes of a series of movements where a human detects situation using the five senses, determines it using a brain, and moves muscle specifically.

More specifically, referring to this document, the coordination ability includes a rhythm ability, a balance ability, a switch-over ability, a response ability, a coupling ability, an orientation ability, and a differentiation ability. The rhythm ability is an ability to represent rhythm of the movement based on visual information, acoustic information, and/or information imaged by a person with a body. The balance ability is an ability to maintain the proper balance and recover the deformed posture. The switch-over ability is an ability to quickly switch over movement in response to the change of condition. The response ability is an ability to quickly respond to a signal to deal appropriately. The coupling ability is an ability to smoothly move an entire body, i.e., an ability to adjust a force and a speed to laconically move a muscle and a joint of the partial body. The orientation ability is an ability to comprehend a positional relation between the moving object and one's own body. The differentiation ability is an ability to link hands and/or feet and/or instruments with a visual input to precisely operate them (the hand-eye coordinaton (coordination between hand and eye), the foot-eye coordinaton (coordination between foot and eye)). The hand-eye coordination may be referred as the eye-hand coordination. Also, the foot-eye coordination may be referred as the eye-foot coordination.

In step S3, the multimedia processor 91 performs evaluation based on the detection result of the input operation of the user by the racket RK and the coordination training task displayed on the television monitor 100, and then outputs the evaluation result as the picture to the television monitor 100.

As has been discussed above, contribution to improvement of the coordination ability of a human is anticipated by making the cartridge 3, the adapter 5, the rackets RK1 and RK2, and the television monitor 100 of FIG. 1 function as the coordination training system. The above response test is mainly associated with the response ability, the orientation ability and the differentiation ability, and therefore it is anticipated that the response test can contribute to improvement of these abilities.

Especially, in the present embodiment, since the user moves the two input devices (rackets) by both hands, the more effective contribution to improvement of the coordination ability is anticipated.

FIG. 17(b) is a transition diagram showing working memory training process of the multimedia processor 91 of FIG. 15. Referring to FIG. 17(b), in step S11, the multimedia processor 91 generates the pictures (e.g., see FIG. 6 to FIG. 13) and the voice which represent a task for training working memory in a brain (referred to as the “working memory task” in the following description) based on the image data and the voice data stored in the memory 93 in accordance with the application program stored in the memory 93, and then outputs them to the television monitor 100. In this case, the pictures include a moving image, a still image, or combination thereof. Also, the working memory task may be indicated with only the picture, only the voice, or the combination thereof.

However, in the present embodiment, the tasks are mainly indicated with the pictures.

Incidentally, the working memory task is a task by which working memory in a brain is consumed. In other words, the working memory task is a task which cooperates with the input operation of the user by the input device (e.g., the racket RK) and increases activity of at least part (e.g., a dorsolateral prefrontal cortex (Brodmann areas 46 and 9)) of a prefrontal cortex in a brain when the user performs the task. The examples of the working memory task include a memory task, an identification task, a rehearsal task, a maze task, Stroop task, a Go/No-Go task, a selection task, a span test and so on, combination of two or more thereof, a dual task method, and so on.

The memory task is a task which requires short term memory, for example, is an N-back task. The N-back task is a task which asks whether or not a currently presented stimulus is same as a stimuli presented several (N) trials previously. Incidentally, the first to third memory tests may be included in the memory task. The identification task is a task which requires to identify a letter, a digit, graphics, a drawing and so on. The rehearsal task is a task which requires to repeat content.

The Stroop task is a task which requires to name or select a color when a word naming the color is displayed in a color different from the color it names (alternatively, when a color surrounding the word naming the color is different from the color it names). Incidentally, the above judgment test may be included in the Stroop task. The maze task is a task which asks the shortest path through a maze. The Go/No-Go task is a task which requires to respond to a stimulus (GO trial) or to appropriately inhibit a response to a stimulus (No-GO trial). The selection task is a task which requires to select an information item as indicated among a plurality of information items. The dual task is a task which requires to perform two different types of tasks in parallel.

The span test is a test which evaluates short term memory mainly, and, for example, includes a digit span test, a word span test, a reading span test, a counting span test, a operation span test, a listening span test, a spatial span test, and so forth. Incidentally, the first to third memory tests may be included in the span test.

The digit span test is a test which requires to memorize a plurality of digits as shown simultaneously or sequentially and asks a question to confirm accuracy of the memory. The word span test is a test which requires to memorize a plurality of words as shown simultaneously or sequentially and asks a question to confirm accuracy of the memory. Needless to say, colors, graphics, drawings, or the like may be use instead of the digit and the word. The reading span test is a test which measures the extent to which there is ability of memorizing words while reading. The counting span test is a test which requires to memorize the number of figures while counting the figures. The operation span test is a test which requires to determine whether or not an answer of a numerical calculation is correct determined, and memorize words as shown adjacent to the numerical calculation therewith. The listening span test is a test which requires to memorize words while listening sentence.

Incidentally, the working memory task includes a task which requires the user to perform predetermined processing under a state where the user memorizes predetermined information temporarily such as the first to third memory tests.

In another aspect, the working memory task is a task which yields the measurement result where electric activity or metabolic activity of nerves of at least one part (e.g., a dorsolateral prefrontal cortex) of a prefrontal area in a brain increases when the electric activity or the metabolic activity of the nerves in the brain is measured during the user performs the task while operating the input device (racket RK).

The electric activity of the nerves in the brain can be measure by means of the Electro-EncephaloGram (EEG), the Magneto-EncephaloGram (MEG), and so on. The metabolic activity of the nerves in the brain can be measure by means of the Positron Emission Tomography (PET), the Near-infrared spectroscopy (NIRS), the functional Magnetic Resonance Imaging (fMRI), the Magnetic Resonance Spectroscopy (MRS), and so on.

The Electro-EncephaloGram (EEG) can be obtained by measuring a scalp potential. The Magneto-EncephaloGram (MEG) can be obtained by measuring magnetic field distribution on a scalp. The functional Magnetic Resonance Imaging (fMRI), Positron Emission Tomography (PET), and the Near-infrared spectroscopy (NIRS) measure cerebral hemodynamics. The Magnetic Resonance Spectroscopy (MRS) measures metabolites inside a brain. When a brain is activated, a blood flow, a blood volume, amount of oxygen in blood, a glucose consumption, and an oxygen consumption inside the brain increase, so that it is possible to confirm an activation site in the brain by measuring them using the above measurement methods. The activation site of the brain may be confirmed only by the measurement result based on the one type of the measurement method, or may be confirmed by the measurement results based on the two or more measurement methods.

In step S13, the multimedia processor 91 performs evaluation based on the detection result of the input operation of the user by the racket RK and the working memory task displayed on the television monitor 100, and then outputs the evaluation result as the picture to the television monitor 100.

As has been discussed above, the user performs the working memory task repeatedly with the aim of training the brain by making the cartridge 3, the adapter 5, the rackets RK1 and RK2, and the television monitor 100 of FIG. 1 function as the working memory training system. Since the electric activity or the metabolic activity of the prefrontal area in the brain increases during performance of the task, i.e., the prefrontal area in the brain is intensively used during performance of the task and whereby activated intensively, the contribution to improvement of the activity of the working memory closely related to the activity of the prefrontal area is anticipated by repeating the task.

By the way, next, the flows of the programs executed by the multimedia processor 91 for the above respective tests will be described using the flowcharts.

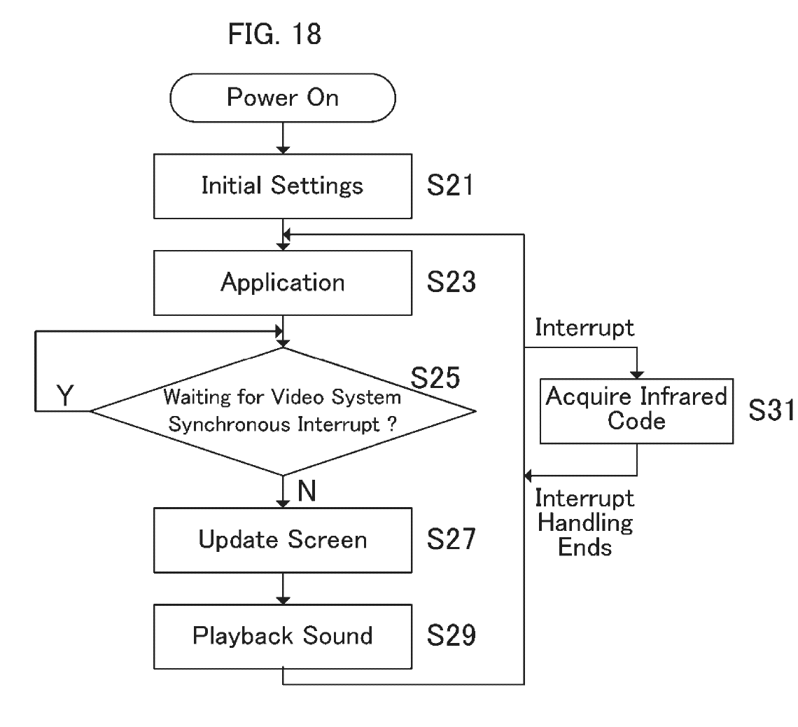

FIG. 18 is a flowchart showing entire operation of the multimedia processor 91 of FIG. 15. Referring to FIG. 18, when the power switch is turned on, in step S21, the multimedia processor 91 performs initialization process of the system. In step S23, the multimedia processor 91 performs processing in accordance with an application program stored in the memory 93. In step S25, the multimedia processor 91 waits until an interrupt based on a video system synchronous signal is generated. In other words, if the interrupt based on the video system synchronous signal is not generated, processing of the multimedia processor 91 repeats the same step S25. If the interrupt based on the video system synchronous signal is generated, processing of the multimedia processor 91 proceeds to step S27. For example, the interrupt based on the video system synchronous signal is generated at 1/60 second intervals. In step S27 and step S29, the multimedia processor 91 performs a process of updating the screen displayed on the television monitor 100 and a process of reproducing the voice in synchronism with the interrupt. Then, processing of the multimedia processor 91 returns to step S23.

When the multimedia processor 91 receives the infrared ray data transmitted by the racket RK (including the 1P/2P distinction information, the level information corresponding to the acceleration data of the racket RK, and the On/Off information of the switch 771) from the IR receiver circuit 71 of the adapter 5, the multimedia processor 91 generates the interruption signal inside thereof. In step S31, the multimedia processor 91 starts processing of acquiring the infrared ray data in response to the interruption signal.

In this case, the multimedia processor 91 performs determination with respect to a clear, a start and a stop of a software counter as described below every time the interrupt based on the video system synchronous signal is generated and then performs one operation of the clear, the start and the stop in accordance with the result of the determination.

Next, the flow of the process of the response test will be described. While the process is performed as the process of the application program which is executed in step S23 of FIG. 18, for the sake of clarity in explanation, the explanation is made with reference to a flowchart of form included in the transition diagram of FIG. 17(a) instead of a flowchart of form synchronized with the video system synchronous signal.

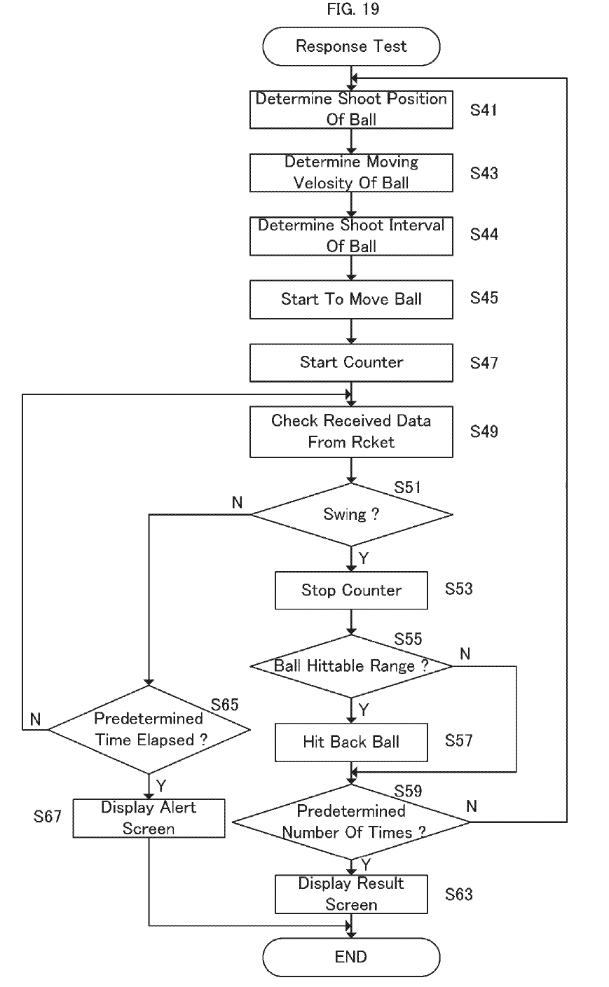

FIG. 19 is a flowchart showing the process of the response test of FIG. 5. Referring to FIG. 19, in step S41, the multimedia processor 91 determines the position of shooting the ball 159 from among the shooting openings 160, 162, 164, 166, 168 and 170 by generating the random number. In step S43, the multimedia processor 91 acquires the moving velocity of the ball 159 from a velocity table by generating the random number. The velocity table is a table where a plurality of different moving velocities is stored, and it is stored into the memory 93. Incidentally, the velocity may be a constant value. In step S44, the multimedia processor 91 acquires the interval of shooting the ball 159, i.e., the time from the disappearance of the ball to the shot of the next ball 159 from a shot interval table by generating the random number. The shot interval table is a table where a plurality of different shot intervals is stored, and it is stored into the memory 93.

In step S45, the multimedia processor 91 shots the ball 159 from the shooting opening determined in step S41 after lapse of the shot interval acquired in step S44, and moves the ball 159 at the moving velocity acquired in step S43. At the same time, in step S47, the multimedia processor 91 starts a software counter (counter on the screen) to count response time. The multimedia processor 91 accesses the main RAM and checks the infrared ray data from the racket RK in step S49, and determines whether or not the racket RK is swung in step S51. Incidentally, when the infrared ray data from the racket RK is stored in the main RAM, it means that the racket RK is swung.

Also, in the present embodiment, the level information of the acceleration data of the racket RK is used as the information for determining whether or not there is the swing.

If the multimedia processor 91 determines in step S51 that the racket RK is swung, the processing proceeds to step S53, conversely, if the multimedia processor 91 determines that the racket RK is not swung, the processing proceeds to step S65.

In step S53, the multimedia processor 91 stops the above counter. In step S55, the multimedia processor 91 determines whether or not the ball 159 is present within a ball hittable range within a prescribed time from when the swing of the racket RK is detected, if it is present the process proceeds to step S57 to display the ball which is hit back in a backward direction, conversely if it is not present the process directly proceeds to step S59.

In step S59, the multimedia processor 91 determines whether or not the processing of steps S41 to S57 is repeated by a predetermined number of times, if it is not repeated the process returns to step S41, conversely if it is repeated the process proceeds to step S63 to display the result screen including the total time of the responses (the final value of the counter).

On the other hand, in step S65 after determining in step S51 that the racket is not swung, the multimedia processor 91 determines whether or not a predetermined time elapses after the shot of the ball 159 with reference to the above counter, if it does not elapse the process proceeds to step S49, conversely, if it elapses the process proceeds to step S67 to display an alert screen because of time out.

Next, flows of the processes of the first to third memory tests, the judgment test, and the first to third comparison-faculty tests will be described. While these processes are performed as the process of the application program which is executed in step S23 of FIG. 18, for the sake of clarity in explanation, explanations are made with reference to flowcharts of form included in the transition diagram of FIG. 17(b) instead of flowcharts of form synchronized with video system synchronous signal.

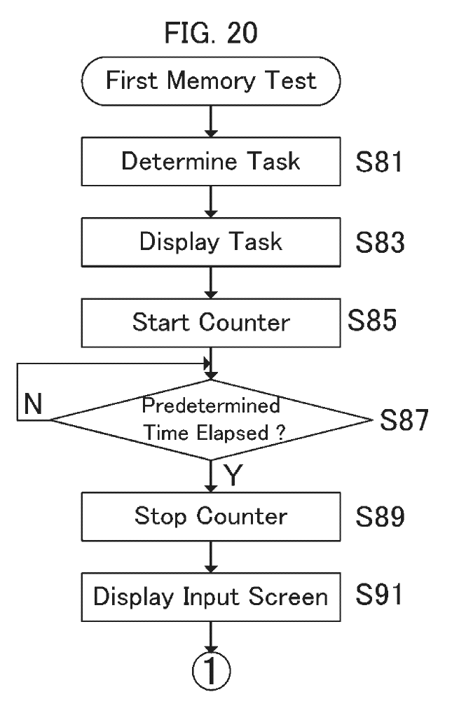

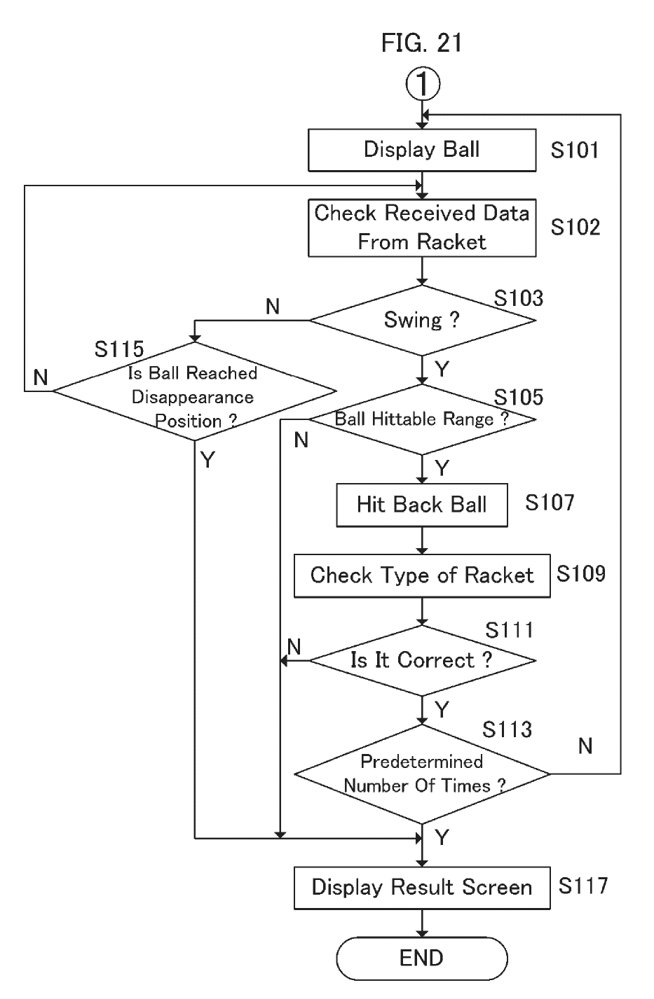

FIG. 20 and FIG. 21 are flowcharts showing the process of the first memory test of FIGS. 6 and 7. Referring to FIG. 20, in step S81, the multimedia processor 91 determines a color (red or blue) for each racket object with regard to the twenty four racket objects to be displayed in the task displaying area 178. In this case, the color is determined by the generating the random number for each racket object.

In step s83, the multimedia processor 91 displays the twenty four racket objects in the task displaying area 178 each of which has the color determined in step S81. At the same time, in step S85, the multimedia processor 91 starts the software counter (counter on the screen) to count the predetermined time given to the user so as to memorize the task displayed in the task displaying area 178.

In step S87, the above counter is checked and it is determined whether or not the predetermined time is elapsed, if it is not elapses the process returns to step S87, conversely if it is elapsed the process proceeds to step S89 to stop the above counter and delete all the racket objects in the task displaying area 178. Alternatively, these may be returned to the neutral color (yellow color).

In step S91, the multimedia processor 91 displays the input screen of FIG. 7. Then, in step S101 of FIG. 21, the multimedia processor 91 shots the ball object 172 from the shooting portion 21 and displays it so as to fly toward the front side.

The multimedia processor 91 accesses the main RAM and checks the infrared ray data from the rackets RK1 and RK2 in step S102, and determines whether or not the rackets RK1 and RK2 are swung in step S103. If the rackets RK1 and RK2 are not swung the process proceeds to step S115, conversely if the racket RK1 or RK2 is swung the process proceeds to step S105. In step S105, the multimedia processor 91 determines whether or not the ball 159 is present within a ball hittable range within a prescribed time from when the swing of the racket is detected, if it is present the process proceeds to step S107 to display the ball which is hit back in a backward direction, conversely if it is not present the process proceeds to step S117 because of the failure of hitting.

In step S109, the multimedia processor 91 accesses the main RAM and checks the infrared ray data to determine which of the rackets RK1 and RK2 is swung. In step S111, the multimedia processor 91 determines whether or not the correct racket is swung in accordance with the task in the task displaying area 178, if it is incorrect the process proceeds to step S117 because of the failure, conversely if it is correct the process proceeds to step S113. In step S113, the multimedia processor 91 determines whether or not the processing of steps S101 to S111 is completed by the predetermined number of times (in the present embodiment, twenty four times), if it is not completed the process proceeds to step S101, conversely if it is completed the process proceeds to step S117.

On the other hand, in step S115 after determining “NO” in step S103, the multimedia processor 91 determines whether or not the ball object 172 reaches the disappearance position, if it does not reach the process returns to step S102, conversely if it reaches the process proceeds to step S117 because of the failure.

In step S117 after determining “YES” in step S113, “NO” in step S111, “NO” in step S105, or “YES” in step S115, the multimedia processor 91 displays the result screen including the number of the racket objects memorized by the user on the television monitor 100.

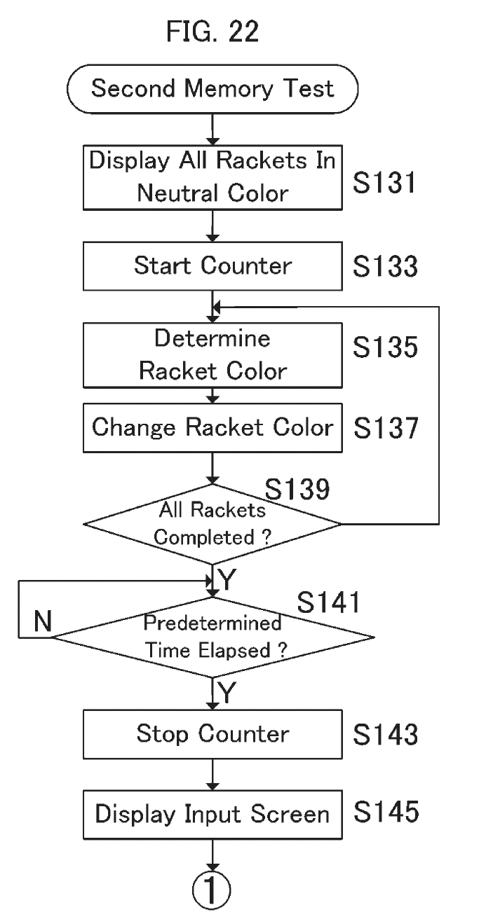

FIG. 22 is a flowchart showing the first part of the process of the second memory test of FIG. 8. Referring to FIG. 22, in step S131, the multimedia processor 91 displays all the racket objects in the neutral color in the task displaying area 178. In step S133, the multimedia processor 91 starts a software counter (counter on the screen) to count a predetermined time given to the user so as to memorize the task displayed in the task displaying area 178.

At the same time, the multimedia processor 91 determines the color of the racket object by generating the random number in step S135, and, in step S137, changes the color of the racket object from the neutral color to the color determined in step S135. In step S139, the multimedia processor 91 determines whether or not the processing in steps S135 and S137 is completed for all the racket objects displayed in the task displaying area 178, if it is not completed the process returns to step S135, conversely if it is completed the process proceeds to step S141.

Then, in step S141, the multimedia processor 91 checks the above counter and determines whether or not a predetermined time is elapsed, if it is not elapsed the process returns to step S141, conversely if it is elapsed the process proceeds to step S143 to stop the above counter and delete all the racket objects in the task displaying area 178. Alternatively, these may be returned the neutral color. In step S145, the multimedia processor 91 displays the input screen of FIG. 7. The subsequent processing is same as that of FIG. 21, and therefore the explanation is omitted.

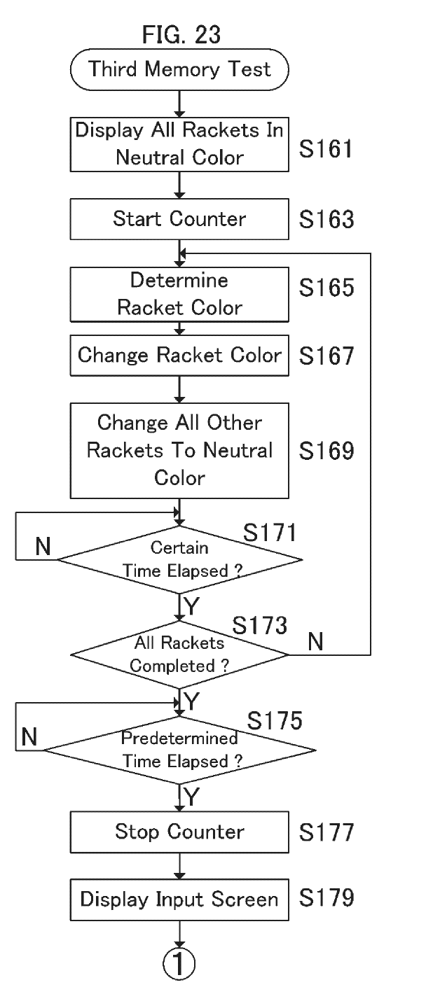

FIG. 23 is a flowchart showing the first part of the process of the third memory test of FIG. 9. Referring to FIG. 23, in step S161, the multimedia processor 91 displays all the racket objects in the neutral color in the task displaying area 178. In step S163, the multimedia processor 91 starts a software counter (counter on the screen) to count a predetermined time given to the user so as to memorize the task displayed in the task displaying area 178. At the same time, the multimedia processor 91 determines the color of the racket object by generating the random number in step S165, then in step S167, changes the color of the racket object from the neutral color to the color determined in step S165, and then in step S169, changes the color of all the racket objects except the changed racket object to the neutral color. In step S171, the multimedia processor 91 determines whether or not a certain time elapses, if it does not elapse the process returns to step S171, conversely if it elapses the process proceeds to step S173. In this case, the certain time is a time which is given to the user so as to memorize the order and the color of the one racket object.

In step S173, the multimedia processor 91 determines whether or not the processing in steps S165 to S171 is completed for all the racket objects displayed in the task displaying area 178, if it is not completed the process returns to step S165, conversely if it is completed the process proceeds to step S175.

Then, in step S175, the multimedia processor 91 checks the above counter and determines whether or not a predetermined time is elapsed, if it is not elapsed the process returns to step S175, conversely if it is elapsed the process proceeds to step S177 to stop the above counter and delete all the racket objects in the task displaying area 178. Alternatively, these may be returned the neutral color. In step S179, the multimedia processor 91 displays the input screen of FIG. 7. The subsequent processing is same as that of FIG. 21, and therefore the explanation is omitted.

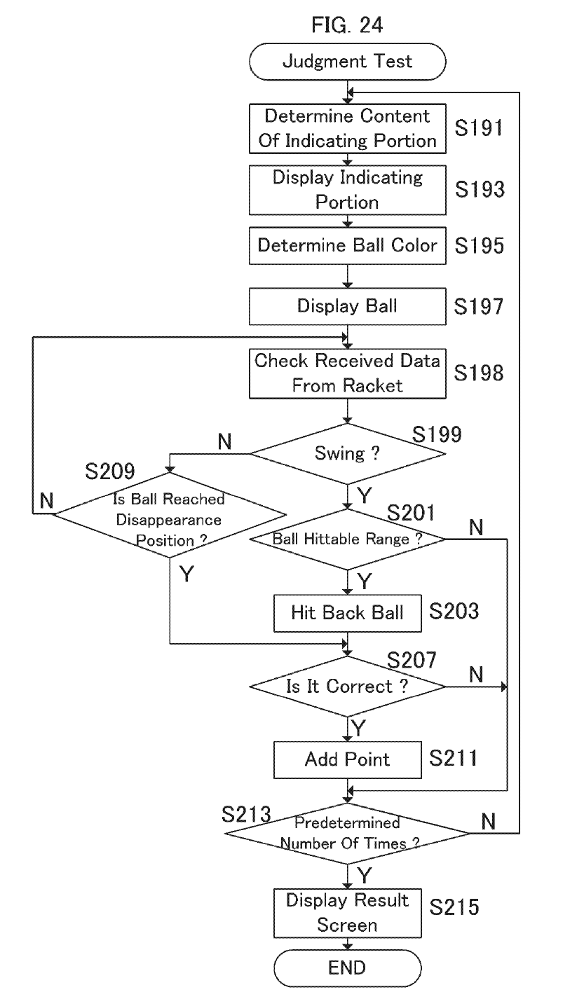

FIG. 24 is a flowchart showing the process of the judgment test of FIG. 10. Referring to FIG. 24, in step S191, the multimedia processor 91 determines the task to be displayed in the indicating portion 174 by generating the random number. In this case, the plurality of tasks capable of displaying in the indicating portion 174 is prepared, associated with the numbers assigned to the respective tasks, and stored as a table in the memory 93.

In step S193, the multimedia processor 91 displays the task determined in step S191 in the indicating portion 174. The multimedia processor 91 determines the color of the ball object 172 by the generating the random number in step S195, and shots the ball object 172 with the color determined in step S195 from the shooting portion 21 and displays so as to fly toward the front side in step S197.

The multimedia processor 91 accesses the main RAM and checks the infrared ray data from the racket RK in step S198, and determines whether or not the racket RK is swung in step S199. If the racket RK is not swung the process proceeds to step S209, conversely if the racket RK is swung the process proceeds to step S201.

In step S201, the multimedia processor 91 determines whether or not the ball object 172 is present within a ball hittable range within a certain time from when the swing of the racket RK is detected, if it is present the process proceeds to step S203 to display the ball which is hit back in a backward direction, conversely if it is not present the process proceeds to step S213 on the assumption of an incorrect answer without exception because of the failure of hitting.

On the other hand, in step S209 after determining “NO” in step S199, the multimedia processor 91 determines whether or not the ball object 172 reaches the disappearance position, if it does not reach the process returns to step S198, conversely if it reaches the process proceeds to step S207.

In step S207 after step S203 or step S209, the multimedia processor 91 determines whether or not the racket RK is swung in accordance with the task in the indicating portion 174. In other words, in the case where the racket RK is swung when it must be swung, or in the case where the racket RK is not swung when it must not be swung, since the fact means the correct answer, the multimedia processor 91 proceeds to step S211 to add one point. On the other hand, in the case where the racket RK is not swung when it must be swung, or in the case where the racket RK is swung when it must not be swung, since the fact means the incorrect answer, the multimedia processor 91 proceeds to step S213 directly.

In step S213, the multimedia processor 91 determines whether or not the processing of steps S191 to S211 is completed by the predetermined number of times, if it is not completed the process returns to step S191, conversely if it is completed the process proceeds to step S215. Then, in step S215, the multimedia processor 91 displays the result screen including the final points on the television monitor 100.

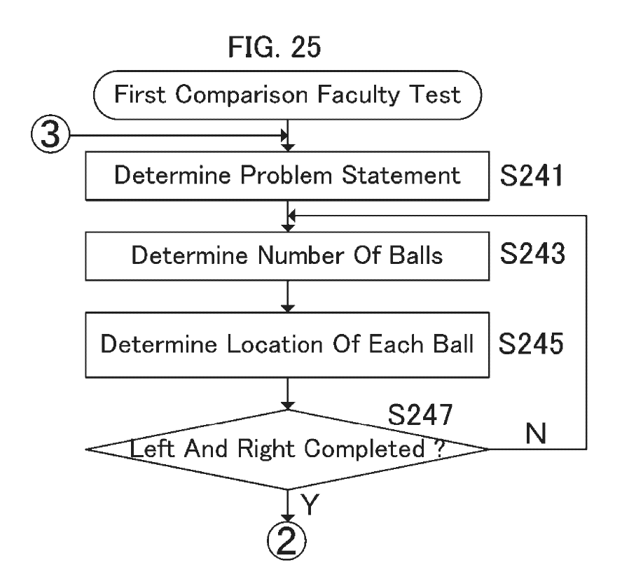

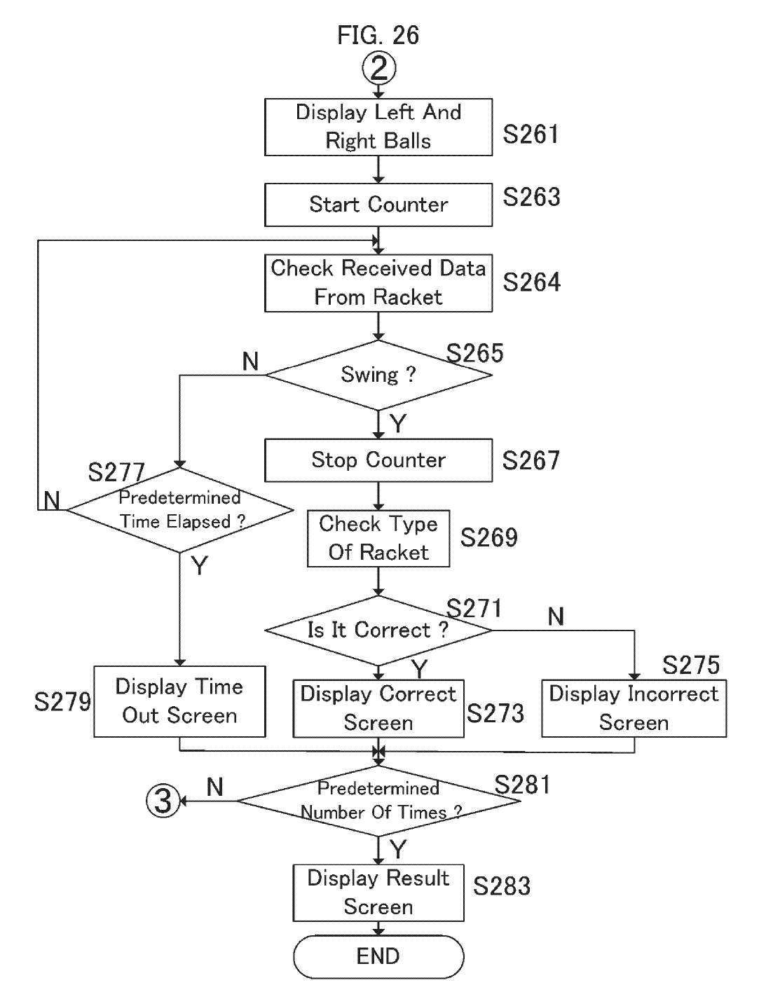

FIG. 25 and FIG. 26 are flowcharts showing the processing of the first comparison-faculty test of FIG. 11. Referring to FIG. 25, in step S241, the multimedia processor 91 determines the problem statement by generating the random number. In this case, the plurality of the problem statements is prepared, associated with numbers assigned to the respective statements, and stored as a table in the memory 93.

In step S243, the multimedia processor 91 generates the random number within a predetermined range to determine the number of the balls to be displayed on the left area 180. In step S245, the multimedia processor 91 generates the random number within a predetermined range to determine the display location (coordinates) of each ball. In step S247, the multimedia processor 91 determines whether or not the processing in steps S243 and S245 is completed for both the left area 180 and the right area 182, if it is not completed the process returns to step S243 to execute the processing for the right area 182, conversely if it is completed the process proceeds to step S261 of FIG. 26.

In step S261 of FIG. 26, the multimedia processor 91 displays the balls as determined on each area of the left area 180 and the right area 182. In step S263, the multimedia processor 91 starts a software counter (counter on the screen) which counts time from the display of the balls to the answer of the user.

The multimedia processor 91 accesses the main RAM and checks the infrared ray data from the rackets RK1 and RK2 in step S264, and determines whether or not the rackets RK1 and RK2 are swung in step S265. If the rackets RK1 and RK2 are not swung the process proceeds to step S277, conversely if the racket RK1 or RK2 is swung the process proceeds to step S267 to stop the above counter.

Then, in step S269, the multimedia processor 91 accesses the main RAM and checks the infrared ray data from the rackets RK1 and RK2 to determine which of the rackets RK1 and RK2 is swung. In step S271, if the correct racket is swung the multimedia processor 91 proceeds to step S273 to display the correct screen, conversely if the incorrect racket is swung the process proceeds to step S275 to display the incorrect screen.

On the other hand, in step S277 after determining “NO” in step S265, the multimedia processor 91 determines whether or not a predetermined time elapses with reference to the above counter, if it does not elapse the process proceeds to step S264, conversely if it elapses the process proceeds to step S279 to display the time out screen.

In step S281, the multimedia processor 91 determines whether or not the processing of steps S241 to S279 is completed by the predetermined number of times, if it is not completed the process returns to step S241 of FIG. 25, conversely if it is completed the process proceeds to step S283 to display the result screen including the number of the correct answers.

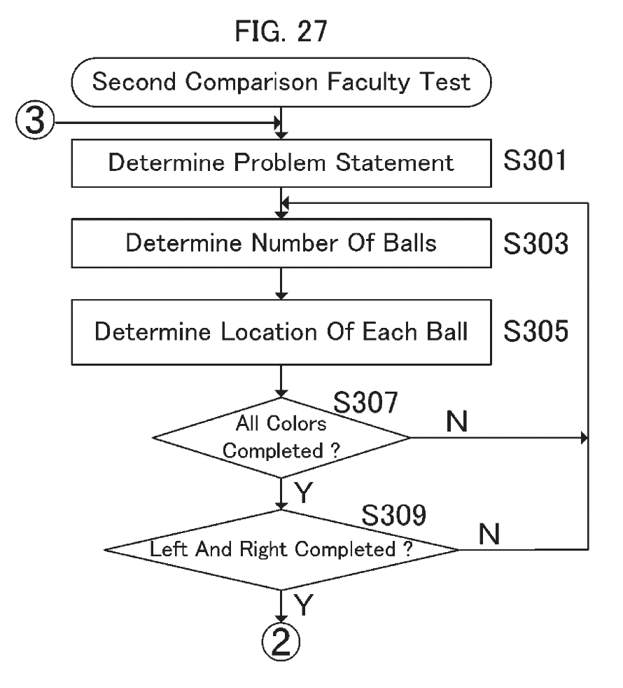

FIG. 27 is a flowchart showing the first part of the process of the second comparison-faculty test of FIG. 12. Referring to FIG. 27, in step S301, the multimedia processor 91 determines the problem statement by generating the random number. In this case, the plurality of the problem statements is prepared, associated with numbers assigned to the respective statements, and stored as a table in the memory 93.

In step S303, the multimedia processor 91 generates the random number within a predetermined range to determine the number of the green balls to be displayed on the left area 180. In step S305, the random number is generated within a predetermined range and whereby the display location (coordinates) of each green ball is determined. In step S307, the multimedia processor 91 determines whether or not the processing in steps S303 and S305 is completed for the balls of all the colors, if it is not completed the process returns to step S303, conversely if it is completed the process proceeds to step S309. In this case, the processing of steps S303 and S305 is executed in order of the green, the blue, the red, and the yellow. In step S309, the multimedia processor 91 determines whether or not the processing in steps S303 to S307 is completed for both the left area 180 and the right area 182, if it is not completed the process returns to step S303 to execute the processing for the right area 182, conversely if it is completed the process proceeds to step S261 of FIG. 26. Incidentally, the subsequent processing is same as that of FIG. 26, and therefore the explanation is omitted.

By the way, flowcharts of the processing for the third comparison-faculty test are the same as the flowcharts of the first comparison-faculty test in FIGS. 25 and 26, and therefore the explanation is omitted.

Next, modifications of the information processing system of FIG. 1 will be described. As described above, the multimedia processor 91 receives the input from the user by receiving the infrared ray dada from the racket RK via the adapter 5. However, the input method from the user is not limited to that, and therefore the other methods may be employed. In the modifications, examples of the other input methods will be described.

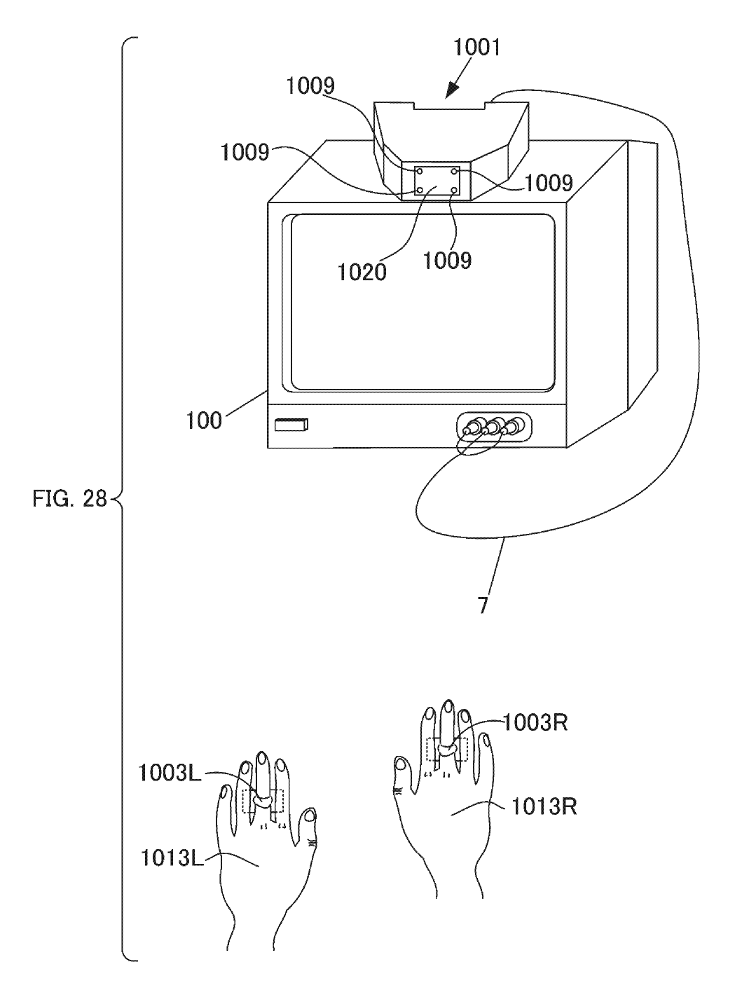

FIG. 28 is an explanatory view for showing the modification of the embodiment in accordance with the present invention. As shown in FIG. 28, an information processing system in accordance with this modification is provided with an information processing apparatus 1001, input devices 1003L and 1003R, and the television monitor 100.

In what follows, the input devices 1003L and 1003R are generally referred to as the “input devices 1003” in the case where they need not be distinguished. The information processing apparatus 1001, the input devices 1003L and 1003R, and the television monitor 100 can serve as the coordination training system and the working memory training system.

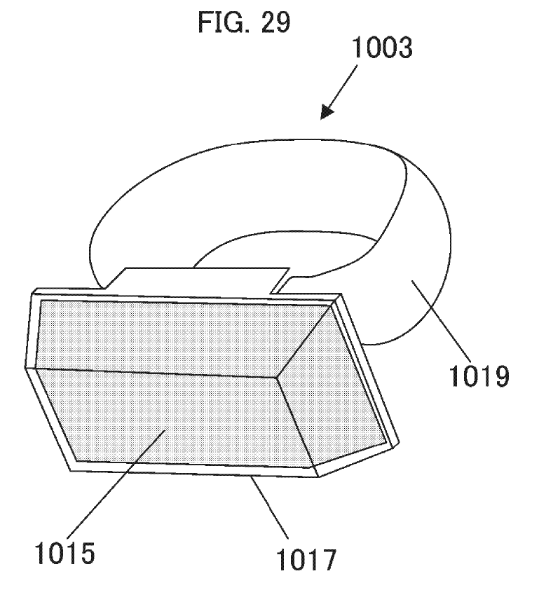

FIG. 29 is a perspective view showing the input device 1003 of FIG. 28. As shown in FIG. 29, the input device 1003 comprises a transparent member 1017 and a belt 1019 which is passed through a passage formed along the bottom face of the transparent member 1017 and fixed at the inside of the transparent member 1017.

The transparent member 1017 is provided with a retroreflective sheet 1015 covering the entirety of the inside of the transparent member 1017 (except for the bottom side). The usage of the input device 1003 will be described later.

In this description, in the case where it is necessary to distinguish between the input devices 1003L and 1003R, the transparent member 1017 and the retroreflective sheet 1015 of the input device 1003L are respectively referred to as the transparent member 1017L and the retroreflective sheet 1015L, and the transparent member 1017 and the retroreflective sheet 1015 of the input device 1003R are respectively referred to as the transparent member 1017R and the retroreflective sheet 1015R.

Returning to FIG. 28, the information processing apparatus 1001 is connected to the television monitor 100 by an AV cable 7. Furthermore, although not shown in the figure, the information processing apparatus 1001 is supplied with a power supply voltage from an AC adapter or a battery. A power switch (not shown in the figure) is provided in the back face of the information processing apparatus 1001.

The information processing apparatus 1001 is provided with an infrared filter 1020 which is located in the front side of the information processing apparatus 1001 and serves to transmit only infrared light, and there are four infrared light emitting diodes 1009 which are located around the infrared filter 1020 and serve to emit infrared light. An image sensor 1054 to be described below is located behind the infrared filter 1020.

The four infrared light emitting diodes 1009 intermittently emit infrared light. Then, the infrared light emitted from the infrared light emitting diodes 1009 is reflected by the retroreflective sheets 1015 attached to the input devices 1003, and input to the image sensor 1054 located behind the infrared filter 1020. Images of the input devices 1003 can be captured by the image sensor 1054 in this way.

While infrared light is intermittently emitted, the imaging process of the image sensor 1054 is performed even in non-emission periods of infrared light. The information processing apparatus 1001 calculates the difference between the image captured with infrared light illumination and the image captured without infrared light illumination when a player moves the input devices 1003, and calculates the location and the like of the input devices 1003 (that is, the retroreflective sheets 1015) on the basis of this differential signal “DI” (differential image “DI”).

It is possible to eliminate, as much as possible, noise of light other than the light reflected from the retroreflective sheets 1015 by obtaining the difference so that the retroreflective sheets 1015 can be detected with a high degree of accuracy.

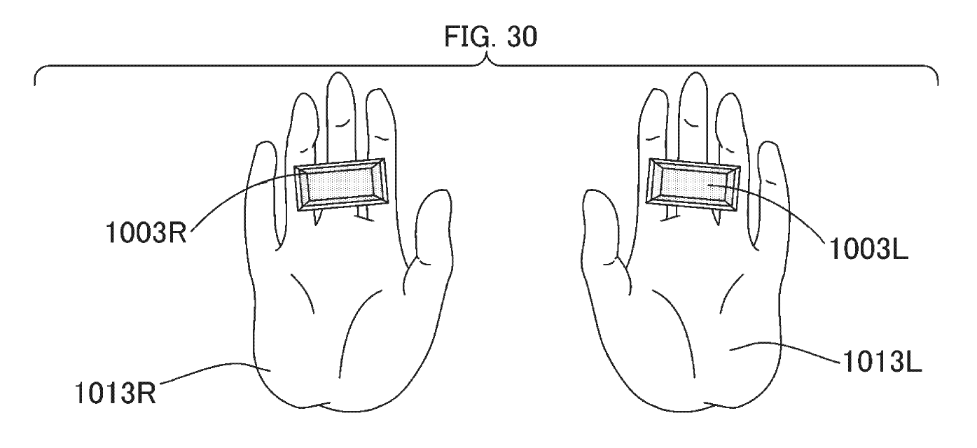

FIG. 30 is an explanatory view for showing an exemplary usage of the input devices 1003L and 1003R of FIG. 28. As illustrated in FIG. 28 and FIG. 30, an operator inserts his or her middle fingers through the belts 1019 of FIG. 16 and whereby wears the input devices 1003. As shown in FIG. 28, if the operator opens the hands facing the information processing apparatus 1001, i.e., the image sensor 1054, the transparent members 1017, i.e., the retroreflective sheets 1015 are exposed, and then images thereof can be captured. On the other hand, if the operator grips the transparent members 1017, the transparent members 1017, i.e., the retroreflective sheets 1015 are hidden in the hands, so that images thereof are not captured by the image sensor 1054.

Accordingly, the operator may or may not have the image sensor 1054 capture images of the retroreflective sheets 1015 by the action of opening or closing hands in order to give an input/no-input to the information processing apparatus 1001. The various tests as described above can be performed using this input method.

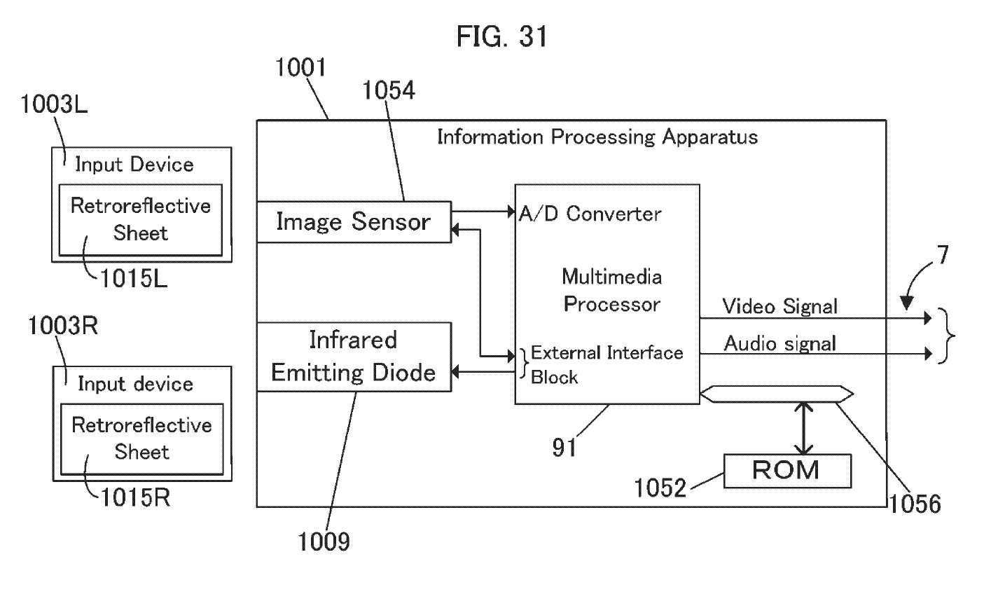

FIG. 31 is a view showing an electrical construction of the information processing apparatus 1001 of FIG. 28. As shown in FIG. 31, the information processing apparatus 1001 includes the multimedia processor 91, an image sensor 1054, infrared light emitting diodes 1009, a ROM (read only memory) 1052 and a bus 1056.

The multimedia processor 91 can access the ROM 1052 through the bus 1056. Accordingly, the multimedia processor 91 can perform programs stored in the ROM 1052, and read and process the data stored in the ROM 1052. The ROM 1052 stores the programs for executing the processes such as the control of the screens for the above various tests, the detection of positions of the retroreflective sheets 1015 and so on, image data, voice data and the like in advance.

As described above, the multimedia processor 91 includes the external interface block and the ADC. The external interface block is an interface with peripheral devices (in the modification, the image sensor 1054 and the infrared light emitting diodes 1009). The ADC is connected to analog input ports of 4 channels and serves to convert an analog signal, which is input from an analog input device (in the case of the modification, the image sensor 1054) through the analog input port, into a digital signal.

By the way, the input devices 1003L and 1003R are illuminated with the infrared light which is emitted from the infrared light emitting diodes 1009, and then the illuminating infrared light is reflected by the retroreflective sheets 1015. The image sensor 1054 receives the reflected light from this retroreflective sheets 1015 for capturing images, and outputs an image signal which includes images of the retroreflective sheets 1015. As described above, the multimedia processor 91 has the infrared light emitting diodes 1009 intermittently flash for performing stroboscopic imaging, and thereby an image signal which is obtained without infrared light illumination is also output. These analog image signals output from the image sensor 1054 are converted into digital data by an ADC incorporated in the multimedia processor 91.

The multimedia processor 91 generates the differential signal “DI” (differential image “DI”) as described above from the digital image signals input from the image sensor 1054 through the ADC. On the basis of the differential signal “DI”, the multimedia processor 91 determines whether or not there is an input from the input devices 1003 and computes the positions and so forth of the input devices 1003, performs an operation, a graphics process, a sound process and the like, and outputs a video signal and audio signals. The video signal and the audio signals are supplied to the television monitor 100 through the AV cable 7 in order to display an image corresponding to the video signal on the television monitor 100 and output sounds corresponding to the audio signals from the speaker thereof (not shown in the figure).

The multimedia processor 91 determines that a input operation is performed, when the retroreflective sheet 1015 of the input device 1003 is detected after the state in which the retroreflective sheet 1015 is not detected. That is, it is determines that the input operation is performed, when the user exposes the retroreflective sheet 1015 by opening after the state in which the user holds the input device 1003.

By the way, in the case of the present embodiment and the modification thereof as has been discussed above, by indicating order of inputting by the two rackets RK1 and RK2 to the user and having the user memorize the order, and further by having the user perform the input operation at indicated timing, it is possible to easily test the extent of the short term memory of the user based on whether or not the input operation is performed using the indicated racket in the indicated order.

In accordance with the present embodiment and the modification thereof, since the judgment of the user is deluded by indicating the feigned input timing to the user, it is possible to easily test the extent of the judgment of the user base on whether or not the input operation by the racket RK is performed at the correct timing.

Also, the elements which delude the judgment of the user are increased by making the color named by the word different from the color of the word itself, or making the color named by the word different from the color of the word itself and the color indicated by the voice, in the indicating portion 174 of FIG. 10, and whereby it is possible to increase the degree of difficulty. Further, it is possible to easily control the degree of difficulty by the number of the elements each of which shows the feigned indication.

In accordance with the present embodiment and the modification thereof, by having the user compare the ball objects as displayed between the left area 180 and the right area 182, it is possible to easily test the extent of the comparison-faculty of the user based on whether or not the result of the comparison is correct.

Also, it is possible to change the degree of difficulty by any one or any combination of number, movement, appearance, size, and moving velocity of the ball objects to be displayed in each area 180 and 182. In this case, the appearance includes shape, design, or color, or any combination thereof.

In accordance with the present embodiment, the user performs the input operation by swinging the rackets RK1 and RK2, it is some kind of exercise, and therefore it is possible to contribute to maintain or improve the health of the user. Similarly, also for the modification, the user performs the input operation by moving the hands to which the input devices 1003L and 1003R are worn, it is some kind of exercise, and therefore it is possible to contribute to maintain or improve the health of the user. Also, the two rackets RK1 and RK2 or the two input devices 1003L and 1003R are used as the input devices. Thus, it is possible to have the user perform the input operation by moving the different parts (the left and right hands in the embodiment) of the body. In contrast, in the case where a plurality of input devices (a plurality of switches) is implemented in a single apparatus such as a remote, it is possible to be operated by a single finger.

Meanwhile, the present invention is not limited to the above embodiments, and a variety of variations and modifications may be effected without departing from the spirit and scope thereof, as described in the following exemplary modifications.

(1) In the example of the above modification, as the condition of determining an input operation, it is set up that a state transition occurs from the state in which the input device 1003 is not detected to the state in which it is detected. However, it is possible to set up as the condition of determining an input operation that a state transition occurs from the state in which the input device 1003 is detected to the state in which the input device 1003 is not detected. Also, it is possible to set up as the condition of determining an input operation that the predetermined movement of the input device 1003, i.e., the retroreflective sheet 1015 is detected.

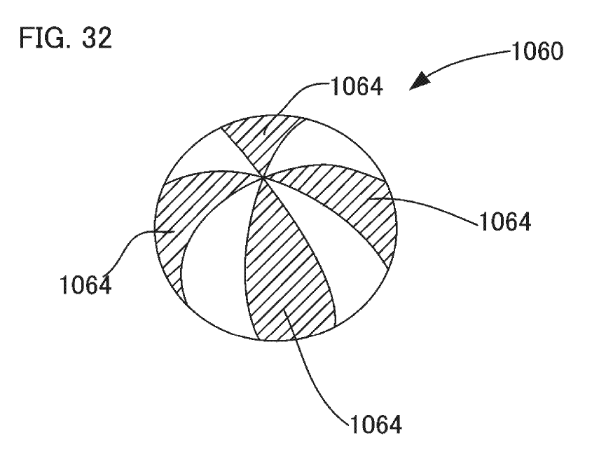

(2) A shape of an input device in the above modification is not limited to the shape of the above input device 1003. For example, as shown in FIG. 32, a spherical input device 1060 may be used. The retroreflective sheets 1064 are attached to surface of the input device 1060. The user holds the input devices 1060 with the respective left and right hands to perform the input operation.

Also, a weight of prescribed weight can be incorporated in the input device 1060 in order that the operator can move the hands in the loading state. In this case, it can more contribute to the maintenance or the promotion of health of the user.

(3) In the above modification, a light-emitting device such as an infrared light emitting diode may be attached to the input device 1003 and 1060 instead of attaching the reflection member such as the retroreflective sheet 1015 and 1064. In this case, it is not necessary for the information processing apparatus 1001 to attach the infrared light emitting diodes 1009. Also, an imaging device such as an image sensor and CCD photographs a user without using the input device, image analysis is performed, and thereby it is also possible to determine whether or not there is an input. In this case, for example, it is possible to determine that there is the input when a predetermined movement is performed.

(4) Further, an image pickup device such as an image sensor and so on may be mounted in an input device and a reflection member such as a retroreflective sheet(s) (one, two, or more) may be attached to a display device (e.g., slightly outside of a screen) such as a television monitor 100. In this case, by obtaining which position on the screen the input device indicates on the basis of the image of the reflection member picked up by the image pickup device, the cursor is displayed at the indicated position and can be operated. In this case, it is possible to have the user perform the working memory task and the coordination training task by the operation of the cursor. Meanwhile, the position on the screen indicated by the input device may be obtained by a computer such as MCU implemented in the input device, or by the multimedia processor 91 on the basis of the image transmitted to the cartridge 3 or the information processing apparatus 1001. In this case, the infrared light emitting diode for stroboscopic imaging is mounted in the input device. Also, a light-emitting device such as an infrared light emitting diode may be attached to the display device instead of attaching the reflection member to the display device (e.g., two infrared light emitting diodes are placed on the upper surface of the display device at a predetermined interval). In this case, it is not necessary for the input device to attach the infrared light emitting diodes for stroboscopic imaging.

Further, various input devices such as two mice and two trackballs can be used instead of the two rackets RK1 and RK2. Furthermore, the input device may include an acceleration sensor (e.g., three axes), a gyroscope (e.g., three axes), a tilt sensor, a magnetic sensor, a vibration sensor or arbitrary combination thereof. In this way, if the user moves the whole input device and the movement of the input device can be detected, the constitution of the input device and a means for detecting the movement thereof are not limited.

While the present invention has been described in terms of embodiments, it is apparent to those skilled in the art that the invention is not limited to the embodiments as described in the present specification. The present invention can be practiced with modification and alteration within the spirit and scope which are defined by the appended claims.

1. A memory testing apparatus comprising:
a plurality of input devices;
an input detecting unit operable to detect whether or not there is an input for said each input device;
an input order indicating unit operable to indicate order of the inputs by said plurality of the input devices to a user by means of a display device; and
an input timing indicating unit operable to indicate timing of the inputs by said input devices to the user by means of the display device.

2. A memory testing apparatus as claimed in claim 1 wherein said plurality of the input devices are provided as a single body respectively.

3. A memory testing apparatus as claimed in claim 2 wherein each of said input devices includes a movement detecting unit which detects movement of said input device and generate a signal in accordance with the movement, and
wherein said input detecting unit determines whether or not there is the input based on the signal from said movement detecting unit.

4. A memory testing apparatus as claimed in claim 3 wherein said movement detecting unit includes an acceleration sensor, and generates the signal in accordance with acceleration detected by said acceleration sensor.

5. A memory testing apparatus as claimed in claim 2 wherein said input detecting unit includes an imaging unit which photographs said input device, and detects whether or not there is the input based on a picture obtained by said imaging unit.

6. A memory testing apparatus as claimed in claim 5 wherein each of said input devices includes any one of a light-emitting unit which spontaneously emits light and a reflection unit which retro reflectively reflects light.

7-11. (canceled)

12. A judgment testing apparatus comprising:
an input device;
an input detecting unit operable to detect whether or not there is an input by said input device;
an input content indicating unit operable to indicate to perform the input using said input device to a user by means of any one or an arbitrary combination of a letter to be displayed on a display device, a drawing to be displayed on the display device, a color to be displayed on the display device, and voice to be output by a sound outputting device;
an input timing indicating unit operable to indicate timing of the input by said input device to the user by displaying an image representing a content which corresponds to a content indicated by said input content indicating unit on the display device and/or by outputting voice representing a content which corresponds to a content indicated by said input content indicating unit from said sound outputting unit; and
a feigned input timing indicating unit operable to indicate feigned timing of the input by said input device to the user by displaying an image representing a content which does not correspond to the content indicated by said input content indicating unit on the display device and/or by outputting voice representing a content which does not correspond to a content indicated by said input content indicating unit from said sound outputting unit.

13. A judgment testing apparatus as claimed in claim 12 wherein said input device includes a movement detecting unit which detects movement of said input device and generate a signal in accordance with the movement, and
wherein said input detecting unit determines whether or not there is the input based on the signal from said movement detecting unit.

14. A judgment testing apparatus as claimed in claim 13 wherein said movement detecting unit includes an acceleration sensor, and generates the signal in accordance with acceleration detected by said acceleration sensor.

15. A judgment testing apparatus as claimed in claim 12 wherein said input detecting unit includes an imaging unit which photographs said input device, and detects whether or not there is the input based on a picture obtained by said imaging unit.

16. A judgment testing apparatus as claimed in claim 15 wherein said input device includes any one of a light-emitting unit which spontaneously emits light and a reflecting unit which retroreflectively reflects light.

17. A judgment testing apparatus as claimed in claim 12 wherein when an indication of the input is performed by means of an arbitrary combination of elements such as the letter, the drawing, the color, and the voice, said input content indicating unit gives a feigned indication by means of the at least one element.

18. A judgment testing apparatus as claimed in claim 12 further comprising:
a determining unit operable to determine whether or not the input by said input device is performed in accordance with the indicated content at the indicated timing.

19-26. (canceled)

27. A coordination training apparatus comprising:
at least one input device operable to detect an input operation of a user;
a task outputting unit operable to output a predetermined task as an image to a display device, and/or, output the predetermined task as voice to a sound outputting device; and
an evaluation outputting unit operable to perform evaluation based on a detection result of the input operation of the user by said input device, and the predetermined task, and output a evaluation result as an image to the display device, and/or, output the evaluation result as voice to the sound outputting device,
wherein the predetermined task includes a task for training an arbitrary combination or any one of an orientation ability, a switch-over ability, a rhythm ability, a response ability, a balance ability, a coupling ability, and a differentiation ability of a human by cooperation with the input operation of the user by said input device,
wherein said task outputting unit repeats to output the predetermined task while changing a content,
wherein said evaluation outputting unit repeats to evaluate in accordance with change of the content of the predetermined task, and
wherein said input device includes a detecting unit which detects movement of said input device and generate a detection signal in accordance with the movement, and detects the input operation of the user based on the detection signal.

28. A coordination training apparatus as claimed in claim 27 wherein the plurality of said input devices is assigned to the one user, and
wherein said evaluation outputting unit performs the evaluation based on the detection results of the input operations of the user by the plurality of said input devices, and the predetermined task.

29. A coordination training apparatus as claimed in claim 27 wherein said detecting unit includes an acceleration sensor, a gyroscope, a tilt sensor, a magnetic sensor, or a vibration sensor, or an arbitrary combination thereof.

30. A working memory training apparatus comprising:
at least one input device operable to detect an input operation of a user;
a task outputting unit operable to output a predetermined task as an image to a display device, and/or, output the predetermined task as voice to a sound outputting device; and
an evaluation outputting unit operable to perform evaluation based on a detection result of the input operation of the user by said input device, and the predetermined task, and output a evaluation result as an image to the display device, and/or, output the evaluation result as voice to the sound outputting device,
wherein the predetermined task is a task which cooperates with the input operation of the user by the input device and increases activity of at least part of a prefrontal cortex of a brain when the user performs the predetermined task,
wherein said task outputting unit repeats to output the predetermined task while changing a content,
wherein said evaluation outputting unit repeats to evaluate in accordance with change of the content of the predetermined task, and
wherein said input device includes a detecting unit operable to detect movement of said input device and generate a detection signal in accordance with the movement, and detects the input operation of the user based on the detection signal.

31. A working memory training apparatus comprising:
at least one input device operable to detect an input operation of a user;
a task outputting unit operable to output a predetermined task as an image to a display device, and/or, output the predetermined task as voice to a sound outputting device; and
an evaluation outputting unit operable to perform evaluation based on a detection result of the input operation of the user by said input device, and the predetermined task, and output a evaluation result as an image to the display device, and/or, output the evaluation result as voice to the sound output device,
wherein the predetermined task is a task which yields a measurement result where electric activity or metabolic activity of nerves of at least one part of a prefrontal area in a brain increases when the electric activity or the metabolic activity of the nerves in the brain is measured during the user performs the predetermined task while operating said input device,
wherein said task outputting unit repeats to output the predetermined task while changing a content,
wherein said evaluation outputting unit repeats to evaluate in accordance with change of the content of the predetermined task, and
wherein said input device includes a detecting unit operable to detect movement of said input device and generate a detection signal in accordance with the movement, and detects the input operation of the user based on the detection signal.

32. A working memory training apparatus comprising:
at least one input device operable to detect an input operation of a user;
a task outputting unit operable to output a predetermined task as an image to a display device, and/or, output the predetermined task as voice to a sound output device; and
an evaluation outputting unit operable to perform evaluation based on a detection result of the input operation of the user by said input device, and the predetermined task, and output a evaluation result as an image to the display device, and/or, output the evaluation result as voice to the sound output device,
wherein the predetermined task is a task which has the user perform a predetermined process under a state where the user memorizes predetermined information temporarily,
wherein said task outputting unit repeats to output the predetermined task while changing a content,
wherein said evaluation outputting unit repeats to evaluate in accordance with change of the content of the predetermined task, and
wherein said input device includes a detecting unit operable to detect movement of said input device and generate a detection signal in accordance with the movement, and detects the input operation of the user based on the detection signal.

33. A working memory training apparatus as claimed in claim 30 wherein the plurality of said input devices is assigned to the one user, and
wherein said evaluation outputting unit performs the evaluation based on the detection results of the input operations of the user by the plurality of said input devices, and the predetermined task.

34. A working memory training apparatus as claimed in claim 30 wherein said detecting unit includes an acceleration sensor, a gyroscope, a tilt sensor, a magnetic sensor, or a vibration sensor, or an arbitrary combination thereof.
